(19) United States
(12) Patent Application Publication
(10) Pub. No.: US 2002/0004694 A1
(43) Pub. Date: Jan. 10, 2002

(54) MODULAR AUTOMOTIVE DIAGNOSTIC SYSTEM

(76) Inventors: CAMERON MCLEOD, MOUNTAIN VIEW, CA (US); MOSHE GRAY, LOS ALTOS, CA (US); GREGORY ROBERTS, SAN JOSE, CA (US)

Correspondence Address: EDWARD D MANZO, 200 WEST ADAMS, SUITE 2850, CHICAGO, IL, 60606

(21) Appl. No.: 09/205,012

(22) Filed: Dec. 4, 1998

Related U.S. Application Data
(60) Provisional application No. 60/067,818, filed on Dec. 5, 1997.

(51) Int. Cl. G06F 13/00; G01M 17/00

(52) U.S. Cl. 701/29; 702/183

(57) ABSTRACT

A modular vehicle diagnostic system includes a plurality of devices substantially enclosed by individual housings are selectively interconnected for sensing or receiving selected signals from a vehicle, for selecting vehicle parameters for vehicle diagnosis or evaluation, for processing the signals, and for displaying the vehicle parameters. The devices are interconnected by conjoining mechanisms associated with the individual housings and/or by having communication channels established between them.

### CROSS REFERENCE TO RELATED APPLICATION

This application claims priority to provisional U.S. application No. 60/067,818, filed Dec. 5, 1997.

### TECHNICAL FIELD

This invention is within the field of automotive diagnostics and pertains to a modular vehicle diagnostic system. As described below, this invention includes a changeable apparatus for sensing, measuring, calculating, processing, and displaying vehicle data and performance parameters.

### BACKGROUND OF THE INVENTION

The industry of automotive diagnostics and repair has changed significantly over the last twenty-five years. Vehicles and engines have become more complicated and vehicle performance standards have increased. Consequently, the complexity of vehicle diagnostic equipment has increased. In addition, vehicle parameters that should be tested have increased and continue to change.

The continual improvement of the automobile has created a challenge for diagnostic and repair shops. Much of the diagnostic equipment that is cutting edge today will very likely have to be updated within a few years. In extreme cases, repair shops abandon or sell (usually at a loss) old equipment and obtain new equipment.

Some repair shops contend with the expense of maintaining modern diagnostic and repair equipment by specializing in particular lines of repair. For example, some automotive repair shops perform ignition system diagnostics but do not perform emissions, electronic control module, or other diagnosis. Specializing in one particular line of repair spares the cost and risk of regularly updating an array of other analysis or repair equipment.

Many repair shops that service a variety of vehicle repair needs find that the service equipment takes up a lot of floor space. This may be because some vehicle repair equipment manufacturers prefer to continue to house the equipment in large, floor standing housings. Also, each piece of service equipment may have its own sets of vehicle probes, keyboard, and display screen. Obviously, if more equipment is present, more time and money will be required to keep the equipment functional and more training will be required to keep service people familiar with the different service equipment protocols.

When working with diagnostic equipment, it is desirable to be able to work with the vehicle probes, view the display screen, and input commands quickly and efficiently. It is also desirable to be able to easily move the diagnostic equipment to different service ports within the service station and to move the equipment around a vehicle under inspection, large or small.

### OBJECTS OF THE INVENTION

It is a general object of the present invention to make a modular vehicle diagnostic system that accommodates the needs of the modern vehicle service technician.

### BRIEF DESCRIPTION OF THE DRAWINGS

In describing a preferred embodiment of the present invention, reference is made to accompanying drawings, wherein:

FIG. 1 is an illustration showing the possible interconnections between several devices of a modular vehicle diagnostic system according to the present invention.

FIG. 2 is an illustration showing the relationships between modular vehicle diagnostic system devices of the preferred embodiment.

FIG is a detailed illustration of the user interface unit of FIG. 2.

FIG. 4 is a detailed illustration of the diagnostics module of FIG. 2.

FIG. 5 shows a schematic of a ground check test circuit that is part of another aspect of the present invention.

FIG. 6 is a detailed illustration of the scan module of FIG. 2.

FIG. 7 is an illustration of the preferred data cable and one interchangeable test adapter for interconnecting the scan module of the preferred embodiment to vehicle's communication link connector.

FIG. 8 is an illustration showing the preferred connection of the data cable of FIG. 7 to the scan module.

FIGS. 9 is a detailed illustration of the amplification module of FIG. 2.

FIG. 10 is a block diagram showing the flow of selected signals from the vehicle computer through the break-out box of FIG. 2.

FIG. 11 is a illustration of the 80 to 4 multiplexer of FIG. 10.

FIG. 12 is a detailed illustration of the ignition signal receiver of FIG. 2.

FIG. 13 is a block diagram of the gas analysis module of FIG. 2.

FIG. 14 is a detailed illustration of the docking station of FIG. 2.

FIG. 15 is a partial flowchart of the preferred serial communications protocol for the modular vehicle diagnostic system of FIG. 2.

FIG. 16 is a partial flowchart of the preferred serial communications protocol for the modular vehicle diagnostic system of FIG. 2.

FIG. 17 is a partial flowchart of the preferred serial communications protocol for the modular vehicle diagnostic system of FIG. 2.

FIG. 18 is a drawing showing the bay structure included in the preferred housing assembly for the user interface unit of FIG. 2.

FIG. 19 is a drawing showing further aspects of the housing assembly shown in FIG. 18.

FIG. 20 is a drawing showing the conjoining relation between the user interface unit housing and the housings for the diagnostics and scan tool modules of FIG. 2.

FIG. 21 is a drawing showing the preferred housing assembly for the diagnostics and scan tool modules of FIG. 2.

FIG. 22 is a drawing further showing the conjoining relation between the user interface unit housing and the housings for the diagnostics and scan tool modules of FIG. 2.

FIG. 23 is a drawing showing tabs and latches of the scan tool module housing and the diagnostics module housing of the preferred embodiment.

FIG. 24 is a drawing showing the housings of FIG. 23 in a locked position.

FIG. 25 is a drawing of the housing for the amplification unit of FIG. 2 conjoined to the user interface unit housing.

FIG. 26 is an drawing of the conjoining mechanism of the user interface unit housing of FIG. 25.

FIG. 27 is a drawing showing a communication channel interconnecting a data processor to the user interface unit of FIG. 2.

FIG. 28 is a drawing showing several communication channels illustrated in FIG. 2.

FIG. 29 is a drawing of an assembly that includes a user interface unit and a diagnostic module.

FIG. 30 shows the conjoining features of the user interface unit housing of the preferred embodiment.

FIG. 31 shows the conjoining features of the diagnostic and scan module housings of the preferred embodiment.

### DESCRIPTION OF THE PREFERRED EMBODIMENT

This invention pertains to modular vehicle diagnostic systems for sensing or receiving selected signals from a vehicle, for selecting vehicle parameters for vehicle diagnosis or evaluation, for accordingly processing the signals, and for displaying the vehicle parameters.

The modular vehicle diagnostic system has a plurality of constituent diagnostic and/or signal processing devices that may be selectively combined to form a vehicle diagnostic assembly. A device may be associated with vehicle diagnosis or performance evaluation or may be associated with some other facet of signal processing and/or interfacing. Two or more devices may be interconnected to produce a single-function or multi-functional vehicle diagnostic assembly unit.

The constituent data processing and diagnostic devices of the modular system may be selectively interconnected to compose a singular vehicle diagnostic assembly unit. Diagnostic assembly units may perform vehicle testing, signal processing, data interfacing and/or other functions.

Diagnostic assembly units may receive signals from a vehicle, process the signals, and/or generate vehicle performance data. Performance data may correspond to ignition system diagnosis, electronic control module (ECM) analysis, emissions or exhaust gas analysis, electrical ground quality, selective component performance evaluations and/or other vehicle operations, systems or components.

Diagnostic assembly units may receive, generate, and transmit vehicle signals for performing signal processing functions including signal multiplexing, artificial signal generating, and vehicle signal modulating.

Diagnostic assembly units may perform data interface functions such as provide a display of vehicle parameters or signal waveforms, receive input from a user, and transfer data to and from external processors or memory storage devices.

Two or more constituent devices may be interconnected by conjoining integral parts of the devices, such as the housings, and/or by providing or establishing one or more electronic communication channel(s) between the devices.

The constituent devices may be conjoined a number of ways. It is preferred that the devices are conjoined with interlocking mechanisms of the type that are at least partially securable to prevent the devices from separating under normal use. For example, in a handheld system, such a secure interlock would allow the operator to grasp any part of an assembly unit and thereby obtain control of all of the interlocked devices. The devices may be conjoined by mating, joining, locking, linking, binding, clasping, or through some other connecting mechanism or technique. For example, the devices may include complementary channels for mating and rotary locking latches, slot and tab assemblies, or Velcro™ strips affixed to the housings. While the above examples provide interlocks that may be relatively easily disengaged, the devices may be conjoined through other means such as screws or nut and bolt assemblies. It should be understood that more than one mechanism may be employed to conjoin devices within an assembly as explained in more detail below.

An interconnection may also be established by providing communication channels between two or more devices. Communication channels may be established in conjunction with, separate from, or exclusive of the conjoining mechanism.

Communication channels allow digital and analog signals to be input to and output from the devices. Digital and analog signals may correspond to data, control, or other information. The devices may transmit and receive automotive-type signals. Automotive-type signals may originate from a vehicle, a memory device, or may be fabricated within the system, with or without input from an operator.

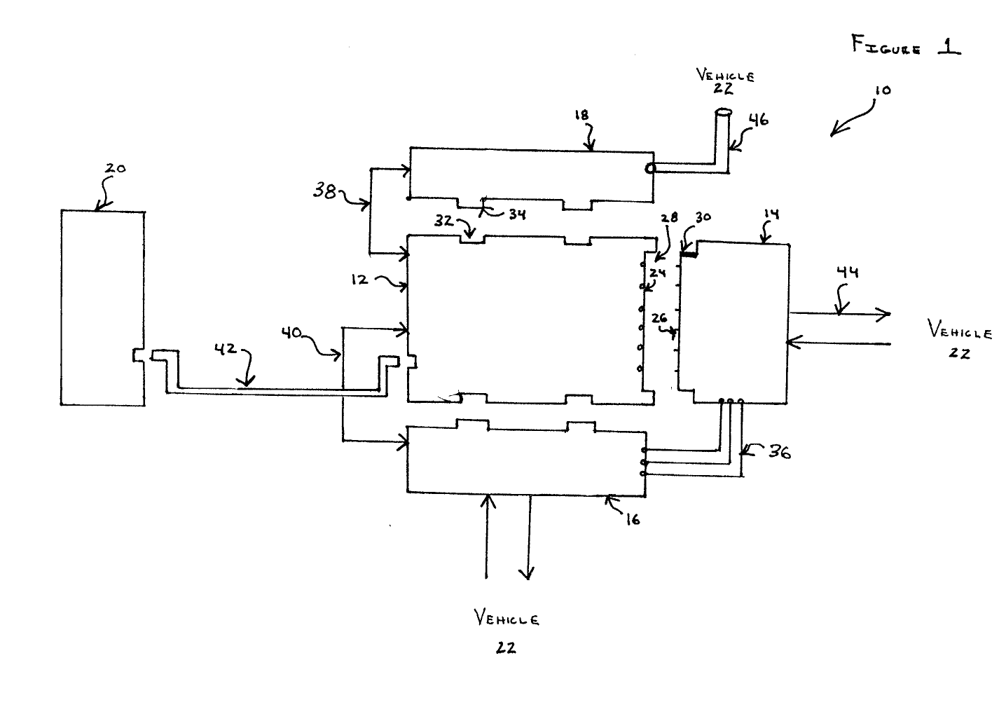

More specifically, a block diagram of a modular vehicle diagnostic system 10 is shown in FIG. 1 and includes several devices 14, 16, 18, and 20 that may be interconnected by being conjoined together and/or through a communication channel.

The devices of the modular vehicle diagnostic system 10 may be selectively interconnected. Either one or several of the devices 12-20 and/or other devices, not shown, may be interconnected to compose an assembly or a device for testing or evaluating vehicle performance. Consequently, each individual device 12-20 may support one or more application(s) for a vehicle diagnostic/evaluation system. For example, the devices within the diagnostic system may include a user interface unit, vehicle signal and data interfacing modules, vehicle signal and data preconditioning modules, and auxiliary components.

A user interface unit may perform one or several universal functions, e.g., displaying test results to an operator on a display and/or receiving input data or information. Consequently, a user interface unit may have application in a majority of diagnostic system applications.

Vehicle signal and data interfacing modules may be provided for performing one or several diagnostic functions, e.g., sensing analog signals from a vehicle and providing an indication of the magnitude of the signals. Such modules may have other applications, e.g., reading data from the vehicle's computer. Interfacing modules may be dedicated to one or several other functions. One, several, or many interfacing modules may be included in the modular vehicle diagnostic system.

Vehicle signal and data preconditioning modules may be provided for performing one or several signal processing functions, e.g., enhancing signals for input to a vehicle component or module vehicle diagnostic system device. Like the interfacing modules, preconditioning modules may have multiple applications. Several preconditioning modules may be included in an assembly unit.

Auxiliary components may be provided for performing other functions. For example, an auxiliary component may be dedicated to analyzing a vehicle's exhaust gas concentrations. One or several auxiliary components may be included in an assembly unit.

It should be understood that the requisite devices for performing vehicle diagnosis or evaluation is dependent upon the type of diagnosis or evaluation performed and the functionality provided by the devices within the modular vehicle diagnostic system.

Returning to FIG. 1, devices 14-20 may interconnect to 12 as shown. Other configurations are possible. For example, device 16 may interconnect to device 18 only or devices 16 and 18 may each be configured to interconnect to device 12 at a single location, so that only one may be interconnected to device 12 at a time.

It is contemplated that different vehicle tests may be performed by various combinations of the devices of FIG. 1. For example, the combination formed by interconnecting devices 12 and 18 may provide an exhaust gas analyzer for providing a display of the concentrations of particular gases present in the exhaust. Alternatively, interconnecting devices 12 and 14 may provide a system for testing the ignition system. As discussed below, further combinations provide assemblies that may test other systems or components of a vehicle.

As illustrated in FIG. 1, the devices of the preferred embodiment are configured to facilitate interconnection. The devices may include reciprocating structure, as illustrated by tabs 30 and 34 and slots 28 and 32, for conjoining the housings of two or more devices. The devices may also be interconnected through communication channels.

Exclusive communication channels may be provided for establishing a signal path between two devices if the devices are otherwise not interconnected. For example, exclusive communication channel 42 may be used to transfer diagnostic data from a memory device within device 12 to memory within device 20.

Preferably, integrated communication channels are associated with the interlocking mechanisms of two or more devices. For example, an integrated communication channel is established between device 12 and device 14 when pins 26 contact slots 24 when tab 30 engages slot 28. Integrated communication channels are preferable if the transfer of large quantities of data between two devices must be fast and/or bidirectional. An integrated communication channel may support a parallel data port without unduly increasing the size or complexity of the system.

Separate communication channels may be provided between two devices if the devices are not otherwise interlocked or the interlocking mechanism does not provide a suitable structure for incorporating a communication channel. For example, separate communication channel 36 interconnects device 14 and device 16, although these devices, while conjoined to other devices within the system, are not conjoined to one another.

Each device within the modular vehicle diagnostic system may execute functions that are related to vehicle diagnosis and/or signal processing. A device may have a local control system, i.e., all of the hardware and/or software for controlling the device is within the device, or may receive control commands or a control program from another module or device.

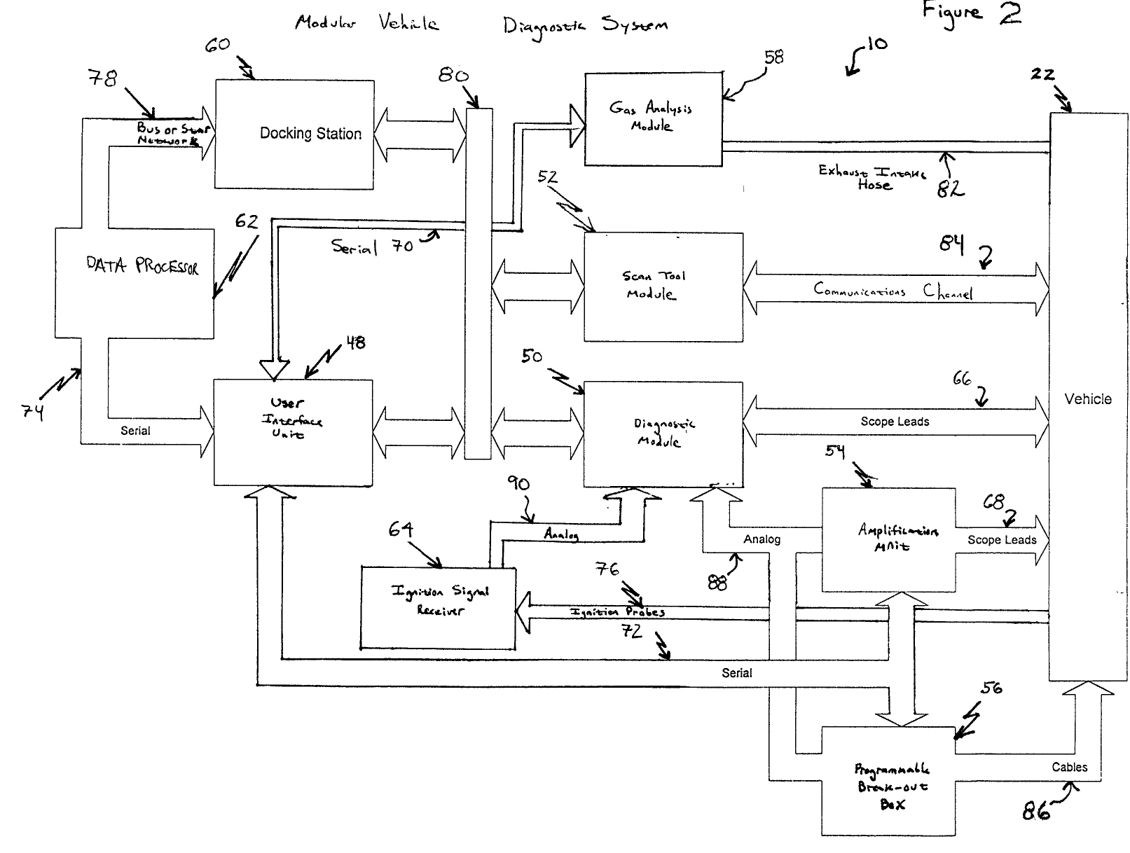

FIG 2 shows, in block diagram form, the preferred embodiment for the modular vehicle diagnostic system of the present invention. The block units represent the devices that may be selectively interconnected. The arrows represent electronic communication channels that may be selectively established. The devices may be conjoined to the same devices with which communication channels are shared or may be conjoined according to some other organizational structure. Conjoining mechanisms are not illustrated in FIG. 2. In the preferred embodiment, selected devices conjoin to the user interface unit 48. In addition, some selected devices, while sharing communication channels, do not conjoin to vehicle diagnostic system devices.

In general, the devices of FIG. 2 include a user interface unit 48, vehicle signal and data interfacing modules 50 and 52, vehicle signal and data preconditioning modules 54, 56, and 64, and auxiliary components 58, 60, and 62 that may be selectively combined.

A user interface unit 48 may have a data processor, display, operator input components, and communication ports for inputting and outputting data and operating commands to and from devices within the system and/or other devices. The user interface unit may have a housing that facilitates selective interconnection to system devices.

Vehicle signal and data interfacing modules 50 and 52 may input and output operating commands, data, and signals. Accordingly, the interfacing modules may transfer data and signals between vehicle format and user interface unit format and may also include preprogrammed memory. An interfacing module may also include a data processor for calculating vehicle performance parameters or performing other functions.

Vehicle signal and data preconditioning modules 54, 56, and 64 may process signals between a vehicle and vehicle signal and data interfacing modules. The preconditioning modules may process data and signals between forms suitable for vehicle or vehicle components and forms suitable for vehicle signal and data interface modules as explained more fully below.

Auxiliary components 58, 60, and 62 may include devices such as digital processors, microprocessors, signal generators, and memory components for transferring, storing, and/or processing diagnostic data and/or control signals from/to the user interface unit, system devices, or vehicle.

### The User Interface

The user interface unit may include a display for displaying vehicle parameters and other information. Displayed information may also include instructions on how to interconnect devices or connect probes to the system, an interactive menu for selecting tests to be performed by the diagnostic assembly and selecting other preferences, such as the preferred display format. Additional information may include the condition or status of components within the system and operator information. For example, the display could request a user id-code from the operator. The display may be a liquid crystal display, cathode ray tube, one or more light emitting diodes, or some other device suitable for communicating information to an operator.

The user interface may also include a device for inputting information. Input information may include the selection of tests to be performed, operating commands, a user-id, format preferences, vehicle information, and other data or commands. An input device may include a touch screen, a keyboard or keypad, up/down buttons, a magnetic signal reader, voice recognition, or other device suitable for receiving operator input.

The user interface may also include a data processor. A data processor may control operation of the user interface unit and/or may control some or all of the interconnected devices. The data processor may include memory for storing or displaying vehicle test data and/or other vehicle information. The data processor may also include memory for storing diagnostic system operation software.

A block diagram of the user interface unit 48 of the preferred embodiment is shown in FIG. 3. User interface unit 48 includes a central processing unit 106 for executing user interface and vehicle diagnostic functions. Central processing unit 106 is interconnected to bus driver 116, bus module interface 142, PCMCIA card slot 140, DRAM memory 122, LCD display RAM 120, keyboard control 108, system address decode & power control 130, and power switch 132. In the preferred embodiment, bus driver 116 is an RS232 driver and module interface 142 is an ISA module interface. Power switch 132 controls PCMCIA power control unit 124 and has a manufacturers part number TPS2201.

Central processing unit 106 is also interconnected to LCD 102 and touch screen interface 100. LCD 102 displays information in alphanumerical and graphical display formats. Information may be input to the modular vehicle diagnostic system through touch screen interface 100.

Central processing unit 106 is also interconnected to PCMCIA power control 124, data and address bus buffers 128, and voltage regulator 110. Voltage regulator 110 is supplied by main power supply 112 under the control of power control logic 114. In the presently preferred embodiment, user interface unit 48 receives power from the vehicle battery via the vehicle's cigarette lighter. The user interface unit may also receive power from a device that receives power from the vehicle battery or from an AC power supply through a DC adapter. User interface unit 48 may also include a battery pack. Batteries may provide operating power and/or backup power during testing.

In the present embodiment, memory device 126 is a basic input/output system (BIOS) and communicates with CPU 106 through buffer data address 128 and system address decode & power control 130. BIOS 126 may include a ROM and/or flash memory chip.

The user interface unit may include other components for vehicle diagnosis. In an alternate embodiment, the user interface unit includes ports for directly receiving vehicle signal scope lead input signals.

The vehicle signal and data interfacing modules may include a diagnostics module and a scan module.

Returning to FIG. 2, diagnostics module 50 inputs analog signals from vehicle 22, processes the signals, and outputs digital data to user interface unit 48. Diagnostics module 50 may also provide signals to vehicle 22 or to other devices within the modular vehicle diagnostic system.

Assuming the devices are interconnected as illustrated in FIG. 2, scope probes and leads 66 sense and transmit analog vehicle signals to diagnostics module 50. Diagnostics module 50 may also receive conditioned analog vehicle signals from amplification unit 54 or programmable break-out box 56. Diagnostics module 50 processes and converts the analog signals to digital data. The digital data may be output through bus 80 to user interface unit 48. Diagnostics module 50 may also output analog signals to amplification unit 54 or directly to vehicle 22.

### A Diagnostics Module

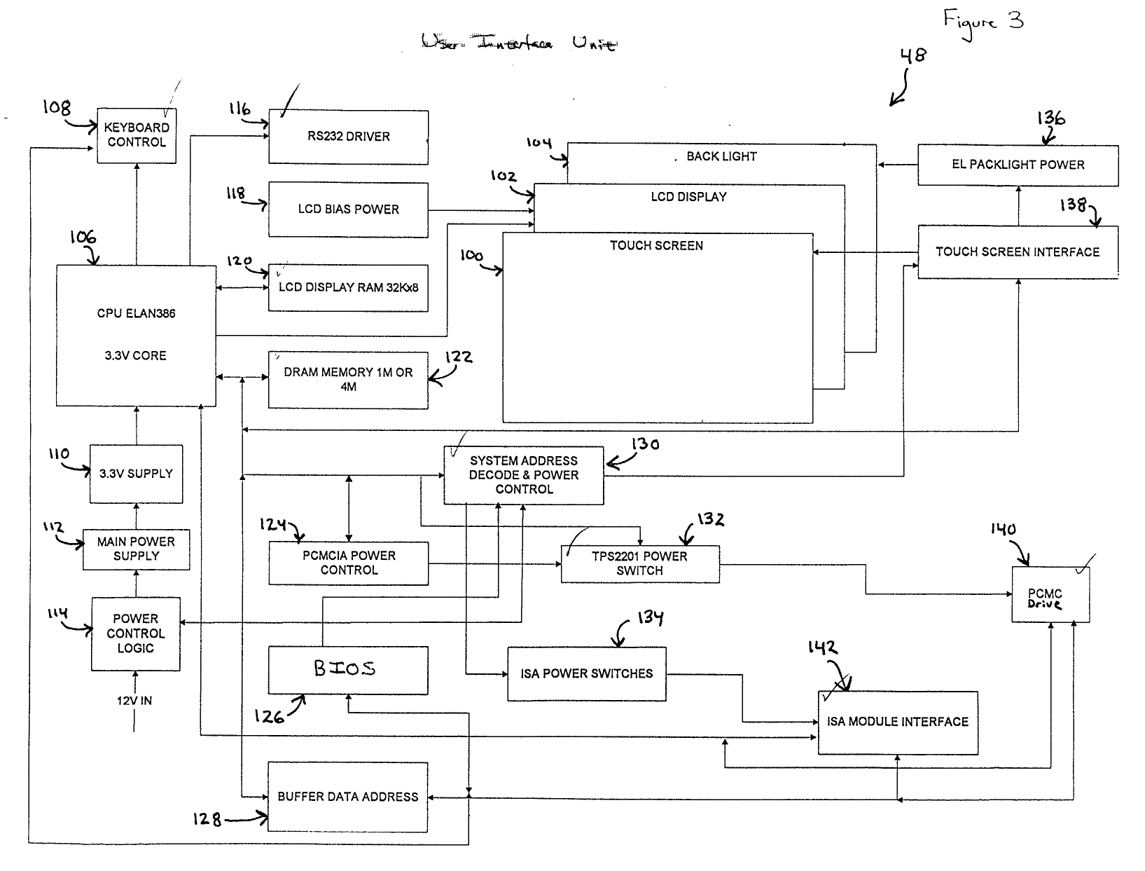

The diagnostics module 50 of the preferred embodiment is shown in FIG. 4. Diagnostic module 50 includes digital signal processor 144 interconnected via digital data communication channel 208 to shared memory device 158 and via digital data communication channel 200 to digital multimeter (DMM) circuitry 162 and DAC multiplying/attenuating circuit 152. Digital signal processor 144 is interconnected via digital data channel 220 and digital control channel 222 to control logic 146.

Control logic 146 is interconnected to DMM circuitry 162, 4-channel multiplexer 150, digital to analog converter (DAC) multiplying/attenuating circuit 152, analog attenuation circuit 154, first-in-first-out memory 156, and shared memory device 158 via digital control channels 206, 224, and 226, as shown. Analog attenuation circuit 154 receives signals from vehicle 32 via four scope lead input channels 166, 168, 170, and 172, designated yellow, green, blue, and red. Vehicle signals are also provided to DMM circuitry 162. Analog attenuation circuit 154 provides analog vehicle signals to DAC multiplying/attenuating circuit 152. Multiplying/attenuating circuit 152 provides vehicle analog signals to output amplification circuit 164 and 4-channel multiplexer 150. 4-channel multiplexer 150 provides vehicle signals to analog-to-digital converter 148. Signal generator voltage reference 176 provides a reference voltage to input channels 170 and 172. In the preferred embodiment, signal generator voltage reference 176 provides +1.2 volts. Ground check circuit 174 may receive battery terminal signals and signals from ground check lead 218. Ground check circuit 174 provides differential voltage signals to input channel 166 and ground voltage signal to input channel 168. Output amplification circuit 164 may provide simulated vehicle signals to vehicle 32. The remaining components may be interconnected as shown in FIG. 4.

As shown in FIG. 2, user interface unit 48 and diagnostics module 50 may be interconnected via bus 80. Returning to FIGS. 3 and 4, user interface unit 48 and diagnostics module 50 communicate via module interface 142 and base unit interface 230.

A vehicle diagnostic assembly including user interface unit 48 and diagnostics module 50 may perform a variety of data processing and vehicle diagnostic functions. Vehicle diagnostic functions may include displaying the magnitudes or frequencies of input signals, measuring resistance, and/or functioning as a digital multi-meter or signal generator.

### Diagnostic Processing Modes

In the present embodiment, the diagnostic module 50—user interface unit 48 assembly may operate to provide a display of an input signal from any one of the four input channels 166-172. In the present embodiment, data may be processed in either one of two modes, (1) normal and (2) FIFO (first-in, first-out). In normal operation mode, an analog signal is digitized and temporarily stored in memory, where it may be accessed by the user interface unit for display. In the FIFO mode, an analog signal is digitized and processed to a register where the data may be accessed by the user interface for display. The FIFO mode is more suitable if a period or segment of an analog signal is digitized to a relatively large number of data points. In an alternate mode, data may be stored in memory and processed to the FIFO register for access by the user interface unit or other module.

If an operator selects the normal mode of operation, firmware from the user interface unit 48 is downloaded to digital signal processor (DSP) 144. Diagnostics module 50 is configured to operate in the normal mode via digital control by the user interface unit 48.

In the normal mode of the present embodiment, analog signals from the input channels are processed to A/D converter 148 via analog attenuation circuit 154 and multiplying/attenuating DAC circuit 152. Digital signals are processed from A/D converter 148 to control logic circuit 146. Digital data is processed in control logic 146 to provide data that is suitable for alphanumeric or graphical display. Control logic 146 outputs data to DSP 144. DSP 144 outputs data to shared memory 158 wherein the data is accessed by the base unit for display on LCD 102. In the preferred embodiment, DSP 144 may process either scope data (i.e., process the digital data samples and output data in a form suitable for a graphical display), or meter data (i.e., calculate average voltage, RMS voltage, frequency, duty cycle, and pulse width), dependent upon the format selected by the operator.

A second mode of operation, referred to as FIFO data mode, is suitable for collecting high concentrations of data. In the FIFO mode, analog signals from the input channels are processed to A/D converter 148 via analog attenuation circuit 154 and multiplying/attenuating DAC circuit 152. Digital signals are processed from A/D converter 148 to FIFO memory 156. Data from FIFO memory 156 may be output directly to user interface unit 48 display. If required by a particular application, data may also be processed by DSP 144 and output to shared memory 158.

### Ground Check

In the present embodiment, the assembly formed by conjoining diagnostic module 50 with user interface unit 48 preferably also operates to provide a display of measurements of the resistance of a vehicle ground circuit. Referring to FIG. 4, diagnostics module 50 is shown to include ground check circuit 174. Ground check circuit 174 may provide up to 250 mA of current for testing the integrity of a ground path.

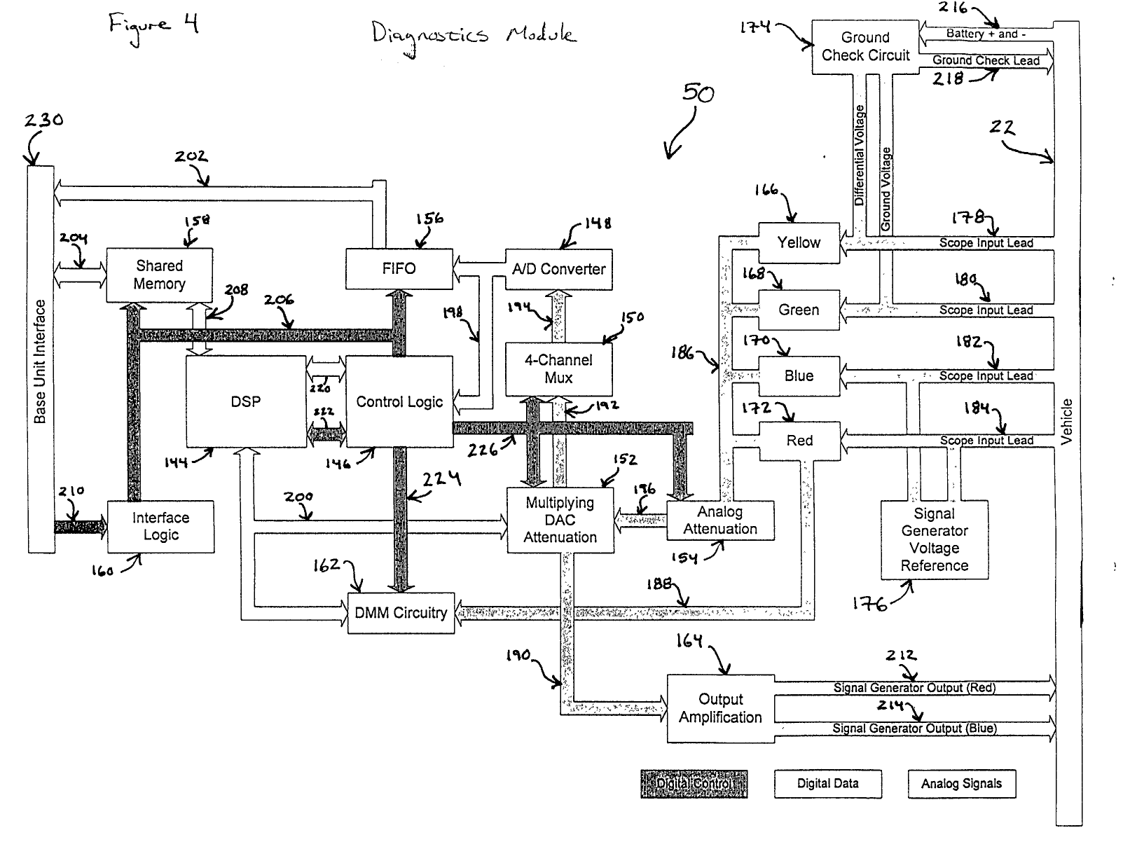

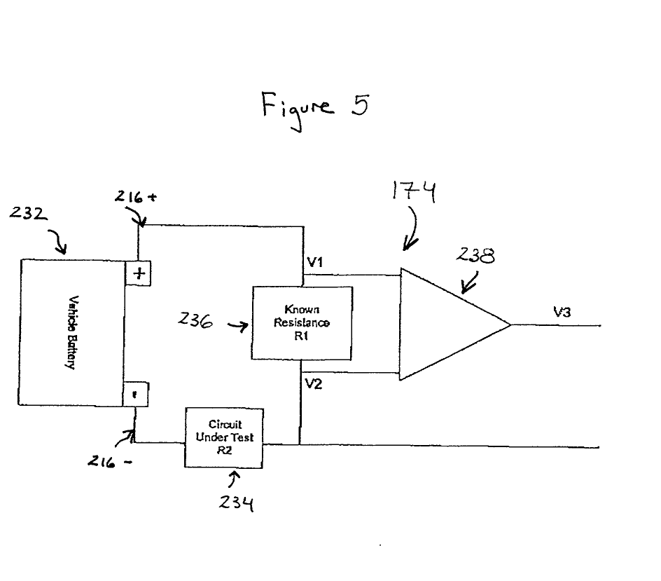

FIG. 5 shows a block diagram of ground check circuit 174 including vehicle battery 232. The loaded ground test of the present embodiment measures the quality of the ground path from a component to the negative terminal of battery 232. In the test, a fixed amount of current is provided to the vehicle electrical system at the point being tested. Using the vehicle battery as a current source, the ground check circuit may simulate operating conditions by providing up to 250 mA of current through a vehicle component.

The positive terminal of vehicle battery 232 provides current for ground check circuit 174. Current from vehicle battery 232 is routed through known resistance 236 and to the vehicle at the test point. Differential amp 238 provides a differential voltage V3, as a function of the drop in voltage from V1 to V2. The voltage levels at V3 and V2 are provided to scope lead input channels 166 and 168, respectively. A/D converter 148 digitizes the voltages. User interface unit 48 further processes the ground check data according to the following formula:

R2=(V2/V3)×R1

User interface unit 48 may display the resistance of the ground path to the negative terminal of the battery, thus providing a check of the integrity of the ground circuit under test.

### Other Functions of the Assembly

The assembly formed by conjoining diagnostic module 50 with user interface unit 48 preferably also functions as a digital multi-meter (DMM) for measuring resistance, current, and DC and AC voltages. In the DMM mode, scope input lead 184 senses electrical signals from vehicle 22. The sensed signals are received by DMM circuitry 162 from analog signals channel 188. DMM circuitry 162 is controlled by control logic 146 and provides to digital signal processor 144 digital data that corresponds to the analog signals from vehicle 22. Digital signal processor 144 processes the digital data to shared memory 158 for access by the user interface unit 48. The base unit displays DMM parameters, including DC voltage, RMS voltage, resistance and current.

The assembly formed by conjoining diagnostic module 50 with user interface unit 48 preferably also functions as a signal generator for simulating vehicle signals. Signals generated by the assembly may be substituted for actual vehicle signals and may be displayed on display 102. At the same time, signals from vehicle sensors, actuators, and/or other vehicle components may be sensed and displayed on display 102. A mechanic may examine the response of a vehicle component under test to a simulated good or bad input signal.

In the signal generator mode, a digitized waveform is output from user interface unit 48 to shared memory 158. The digitized waveform may be read from a personal computer memory card inserted into personal computer memory card drive 140 or may originate at the user interface unit under control of an operator. The user interface unit may be programmed to receive waveform parameters via touch screen 100. The user interface unit may generate one or several periods of the digital waveform to shared memory 158 via module interface 142. A digitized waveform read from a memory card may also be modified by an operator through commands entered on the touch screen.

A digital waveform entered into shared memory 158 may be read by DSP 144. DSP 144 outputs the digital waveform data to multiplying/attenuating DAC 152. DAC 152 outputs the simulated analog waveform to output amplification circuit 164. The simulated waveform may be amplified or modulated and provided to a component of vehicle 10 via signal generator output leads 212 and 214. The simulated waveform may be provided to an actuator, sensor or some other vehicle component while the digitized version of the waveform may be displayed on display 102.

As simulated analog signals are output through leads 212 and 214, vehicle signals may be sensed by input leads 178-184 and processed by diagnostics module 50 to shared memory 158. Operating under the control of DSP 144, multiplying/attenuating DAC 152 may both receive analog signals from analog attenuation circuit 154 and provide an analog signal to output amplification circuit 164.

An alternate method for displaying simulated signals on display 102 includes outputting the simulated signals from output amplification circuit 164 and simultaneously sensing the signals at input channels. The signals may be processed to user interface unit 48 for display on LCD display 68, as described above.

### The Scan Module

Interfacing modules may also include a scan module. A user interface unit 48—scan module 52 assembly communicates with the vehicle via the vehicle's on-board data communication link connector and displays collected information regarding vehicle systems, including engine control, automatic breaking, cruise control, electronic ride control, and transmission control systems. The scan assembly may allow an operator to retrieve trouble codes, run tests, record data, and display information in text, chart, or graphic format.

The scan assembly may receive vehicle information from vehicle data communication links and may thereby monitor sensor, switch and actuator inputs and outputs, run tests, including road tests, and receive and record trouble codes, data lists, component parameters, and control module information.

Scan module 52 may further provide access to vehicle data lists for display of both discrete (e.g., on/off, open/closed) and analog (e.g., magnitude) parameters. The parameters may correspond to input and/or output programmable control module signals. For example, control module data parameters may correspond to engine speed, brake switches, fuel metering, throttle position, engine and engine coolant temperature, barometric and manifold pressure, air temperature, airflow rate, battery voltage, fuel pump relay voltage, spark timing, emissions, transmission and cruise control, and heating, ventilation, and air conditioning systems.

The assembly formed by interconnecting the scan module preferably includes touch screen 100 on the user interface unit 48 (see FIG. 3) for inputting information such as the identity or make of the vehicle, the vehicle system to be tested, and preferred or selected display formats. The scan assembly also includes LCD display 102 for displaying scan test information and other information such as identifying the correct vehicle test adapter and/or providing instructions of how to connect the scanner to the vehicle.

Turning to FIG. 2, therein is shown scan module 52 in communication with bus 80 and interconnected to vehicle 22 via communications channel 84. In the present embodiment, communications channel 84 is a serial communications channel.

A block diagram of scan module 52 is shown in FIG. 6. Scan module 52 communicates with user interface unit 48 via serial port 278 and module interface 142. Serial port 278 is interconnected to serial data channel 280 and data bus and control signal channel 282. Serial data channel 280 is interconnected to microcontroller 274. Microcontroller 274 communicates with programmable logic device 284 via address bus 286 and data bus and control signal channel 288. Microcontroller 274 also communicates with 16-bit transceiver 294 and static RAM devices 290 and 292 via address data bus and control signal channel 288.

Microcontroller 274 controls the overall operation of scan module 52. Programmable logic 284 and programmable logic 318 provide control logic, address decode and other control signals. 16-bit transceiver 294 communicates with serial port 278 and module interface 300 via data bus and control signal channel 282. Programmable logic device 284 transmits memory address data to static RAM 290 and 292 via address bus 296.

Microcontroller 276 implements all of the vehicle-specific serial communication protocols established by the different vehicle manufacturers.

In the presently-preferred embodiment, software for the scan assembly is stored on memory cards. A first memory card may contain all the scan module program software and support for generic and enhanced OBD-II engine control tests. The first card may also contain tests for electronic systems such as ABS, cruise control, electronic ride control, and transmission control. A second memory card may contain engine control system tests for American and foreign vehicles, and tests for other electronic systems on late model vehicles which may also include ABS, cruise control, electronic ride control, and transmission control. The memory cards are read by user interface unit 48 which downloads the information to the scanner module.

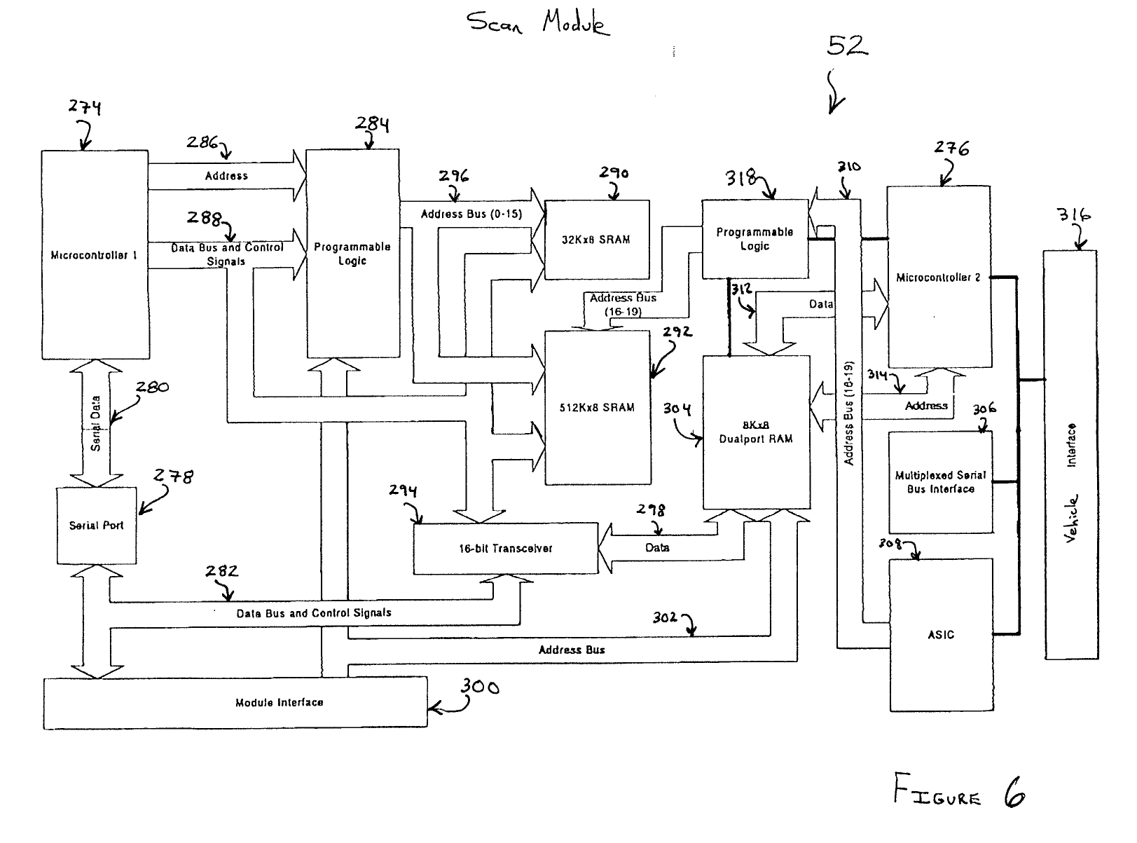

Vehicle interface 316 may include a data cable 240 and an interchangeable test adapter 242, shown in FIGS. 7 and 8, for facilitating interconnection to a vehicle. An interchangeable test adapter of the present invention may include any one of a plurality of adapters configured to attach to a vehicle's communication link connector.

Vehicle signal and data preconditioning modules may include an ignition system signal module, an amplification module, and a programmable break-out box module.

### An Amplification Module

An amplification module may enhance and/or modify modular diagnostic system signals. By enhancing signals, the module vehicle device system widens the range of signal output options for simulating a greater number of vehicle engine control and other signals. An amplification unit may also provide power and ground sources for activating injectors and other devices.

Turning once again to FIG. 2, an amplification unit 54 may receive signals from diagnostic module 50 via analog channel 88. The amplification unit enhances and/or modifies signals under control of user interface unit 48 via serial communication channel 72. Processed analog signals may be output to vehicle 22 via scope leads 68.

FIG. 9 shows a block diagram of the amplification unit 26 for the presently-preferred embodiment. Amplification unit 26 receives signals from diagnostic module 50 at input terminals 344 and 346 and outputs amplified or modified signals at output terminals 352 and 354. Microcomputer 342 may receive commands from user interface unit 48 at serial interface 340. Microcomputer 342 may also send status messages to the user interface unit via serial interface 340.

Amplification unit 54 may have several selectable operation modes. For example, amplification unit 54 may receive and amplify signals through several ranges. For example, in a first mode amplification unit may output a signal having a voltage range of ±6 v and in a second mode may output a signal having a voltage range of ±16 v. In a third mode, power and/or ground sources may be provided for example, to activate selected vehicle components. The amplification unit may include further modes of operation to amplify or modify signals in additional ways, depending upon a desired application. Preferably, an operator may select a desired mode through touch screen interface 100.

Signals input to amplification unit 54 may include pre-configured signal patterns stored as digital data within the modular vehicle diagnostic system or on a disk or memory card. Input signals may also be programmed or input by an operator or through an external source. The signals may be displayed on LCD display 102 for operator verification or for other purposes. In the preferred embodiment, digital signals (or waveforms) are converted to analog signals by diagnostic module 50. Analog signals are amplified or modified by amplification unit 54 for input to vehicle 22. For example, analog signals may be provided by the modular vehicle diagnostic system to drive one or several fuel injectors, activate an automatic breaking system solenoid, or may be provided to a vehicle computer, digital or analog CAM sensor, air temperature sensor, or other device.

Amplification module 54 may include a data processor such as a microprocessor, digital signal processor, or digital controller for controlling or regulating the amplification or modification of signals received.

Referring to FIG. 9, amplification module 54 includes microcomputer 342 for receiving data or information from user interface unit 48 via serial interface 340 and serial driver 116. The data or information received by microcomputer 342 may pertain to the input signals received at inputs 344 and 346, amplification or modification parameters, control parameters for configuring the components within the amplification unit, or some additional aspect of signal modification or amplification. Microcomputer 342 outputs configuration or control signals for configuring amplification unit 54.

In the signal amplification mode, microcomputer 342 receives signals from user interface unit 48 that correspond to the voltage range of the desired amplification module output signal. Microcomputer 342 responsively provides a corresponding reference voltage signal to output lead 356. Assuming the system is interconnected in a manner consistent with the present description, output lead 356 provides a reference voltage signal to signal generator voltage reference circuit 176 of diagnostics module 50. In the presently-preferred embodiment, the reference voltage provided by microcomputer 342 corresponds to the desired output signal voltage range as follows:

| Output signal voltage range | Reference voltage |
|---|---|
| ±6 v | .72 |
| ±16 v | .96 |

Diagnostics module 50 receives from the user interface unit digital data that corresponds to the shape of the desired output signal. The digital data is converted to an analog signal at digital to analog converter 152. The analog signal is amplified to within a predefined voltage range at output amplification circuit 164. The predefined voltage range corresponds to the reference voltage at signal generator voltage reference 176 as follows:

| Reference voltage | Voltage range of output signal |
|---|---|
| .72 | 0-6 v |
| .96 | 0-8 v |

In addition to providing a reference voltage to the diagnostics module, microcomputer 342 configures amplification module buffer amplifiers 348 and 350 to provide a voltage shift of the signal output by output amplification circuit 164. Microcomputer 342 also configures power amplifiers 378 and 380 to provide a voltage gain. The voltage shift and voltage gain are dependent upon the parameters of the desired output signal, as follows:

| Output signal range | Gain Formula |
|---|---|
| ±6 v | output = 2*(input − 3) |
| ±16 v | output = 4*(input − 4) |

The signal amplified at power amplifier 380 is output at signal output lead 354. The signal amplified at power amplifier 378 is provided to relay 382 for selective output to output lead 352. In signal amplification mode, relay 384, under control of microcomputer 342, provides the output of buffer amplifier 348 to power amplifier 378. In a different mode, described below, relay 384 provides the output of buffer amplifier 348 to decoder logic circuit 386.

Amplification module 54 may also operate in a driver mode. In the driver mode of the present embodiment, amplification module 54 outputs half-bridge driving signals (i.e., source or sink current waveforms).

Amplification module 54 generates source and/or sink currents through microcomputer control of decoder logic circuit 386. Decoder logic circuit 386 controls the status of high current drivers 388 and 390 for providing an output signal at output lead 352.

In the present embodiment, microcomputer 342 configures decoder logic 386 to be responsive to signals provided by diagnostics module 50 and received at amplification module input channel 344. Decoder logic 386 controls current drivers 388 and 390 to provide the following outputs to relay 382 in response to the voltage received at input channel 344:

| Voltage from Diagnostics Module | Output Current Source or Sink |
|---|---|
| 10 V | 15 A source |
| 8 V | 5 A source |
| 6 V | 0 A |
| 4 V | 5 A sink |
| 2 V | 15 A sink |

In the driver mode, microcomputer 342 controls relay 384 to provide an output signal to decoder logic 386 and controls relay 382 to receive an input signal from the high current driver circuit.

It should be clear that, in the present embodiment, the amount of source or sink current provided by the modular vehicle diagnostic system at output 352 is determined by the magnitude of the voltage provided by diagnostics module 50. The voltage magnitude parameter may be provided by an operator, an external memory device, the diagnostics module, or some other device.

In the driver mode, the modular vehicle diagnostic system may measure and provide a display of the magnitude of the source or sink current. To determine the source current, differential operational amplifier 392 inputs the voltage differential across resistor 396 and outputs the magnitude thereof at output lead 368. Diagnostic module 50 receives the voltage magnitude, converts the analog magnitude to a digital value and provides the digital value to user interface unit 48. User interface unit 48 calculates the source current and may provide a display thereof on LCD display 102.

Similarly, the magnitude of the sink current may be determined by providing the voltage differential across resistor 398 to the user interface unit.

Amplification module output signals may be displayed on LCD display 68. The “ideal”, or expected, waveform may be displayed by detecting the output of DAC circuit 152, converting the analog signal to a digital signal, and providing the digital signal to user interface unit 48 for display. The “actual” waveform may be observed by coupling amplification unit input lead 374 or 376 to amplification unit signal output lead 352 or 354. Amplification unit input leads 374 and 376 are output to diagnostics module 50 at communication channels 366 and 372, respectively. Diagnostics module 50 may digitize the input signals and provide the signals to user interface unit 48 for display, as described above. Driver mode output waveforms may also be displayed.

In a further aspect of the present invention, the modular vehicle diagnostic system may sense and display the input or output voltage signal from a vehicle component. Amplification unit input leads 374 and 376 may be coupled to a vehicle component lead to sense input or output signals and provide the signals to diagnostic module 50 via leads 366 and 372, as described above.

In summary, a modular vehicle device assembly that includes an amplification module as described may drive a high powered vehicle component, detect the response of the driven component or of some other component in the vehicle, and display the driving signal and detected response signals on the same display screen. Therefore, a mechanic may methodically analyze an engine by injecting known (good or bad) signals directly to one or more vehicle components. Vehicle components may thereby be tested without being removed.

### Break-Out Box

In a further aspect of the invention, a programmable break-out box module may be interconnected to a modular vehicle diagnostic assembly. A programmable break-out box module may sense all or several signals at the vehicle computer and output selected signals to other devices for processing, display, or performing diagnostic functions.

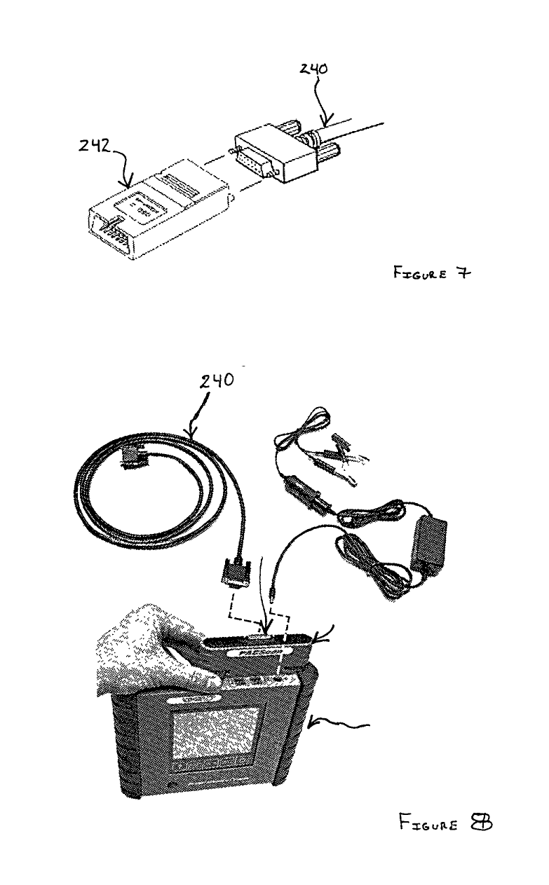

In the presently-preferred embodiment, signals between vehicle 22 and vehicle computer 400 are sensed by connectors 402, as illustrated in FIG. 10. In the present embodiment, the configuration of the connectors is dependent upon the vehicle model. The connectors provide programmable break-out box module 56 a binary code correspondent to the connector configuration and, hence, the vehicle model. As explained below, the programmable break-out box module 56 utilizes the binary code to control operation. Programmable break-out box module 56 receives control signals from user interface unit 48 and provides selected vehicle signals to diagnostic module 50. While the selected vehicle signals may be either analog or digital vehicle signals, programmable breakout box 56 provides the vehicle signals as analog signals to diagnostic module 50, where the signals are digitized, processed, and output to user interface unit 48.

In the presently preferred embodiment, user interface unit 48 provides control signals to programmable break-out box 56 through serial communication channel 72. Break-out box 56 detects signals at the vehicle computer and provides up to four signals to diagnostic module 50.

Referring to FIG. 10, therein is illustrated a block diagram of a break-out-box 56 of the present embodiment. Generally speaking, break-out-box 56 is a controllable analog multiplexer with buffered protected inputs and internal voltage dividers.

The signals detected by the connectors 402 are provided to an input circuit 406. Input circuit 406 protects break-out box module circuitry from excessive vehicle voltage signals. In the presently preferred embodiment, input circuit 406 includes 80 channels, each having a voltage follower and voltage divider circuit. Each channel may process an input signal having a magnitude of up to 50V and is protected to 100V for constant voltage signals and to 300V for short-term voltage spikes. Input circuit 406 also includes 1:12 voltage dividers for scaling down the input voltages.

In the present embodiment, break-out-box 56 functions as a 79-by-4 serially controlled analog multiplexer. An 80-to-4 multiplexer 408 receives input signals from input circuit 406. Seventy-nine (79) of the inputs are vehicle computer signals and one input is provided by the vehicle battery. Under the control of microcontroller 404, multiplexer 408 provides up to four input signals to buffer circuit 410.

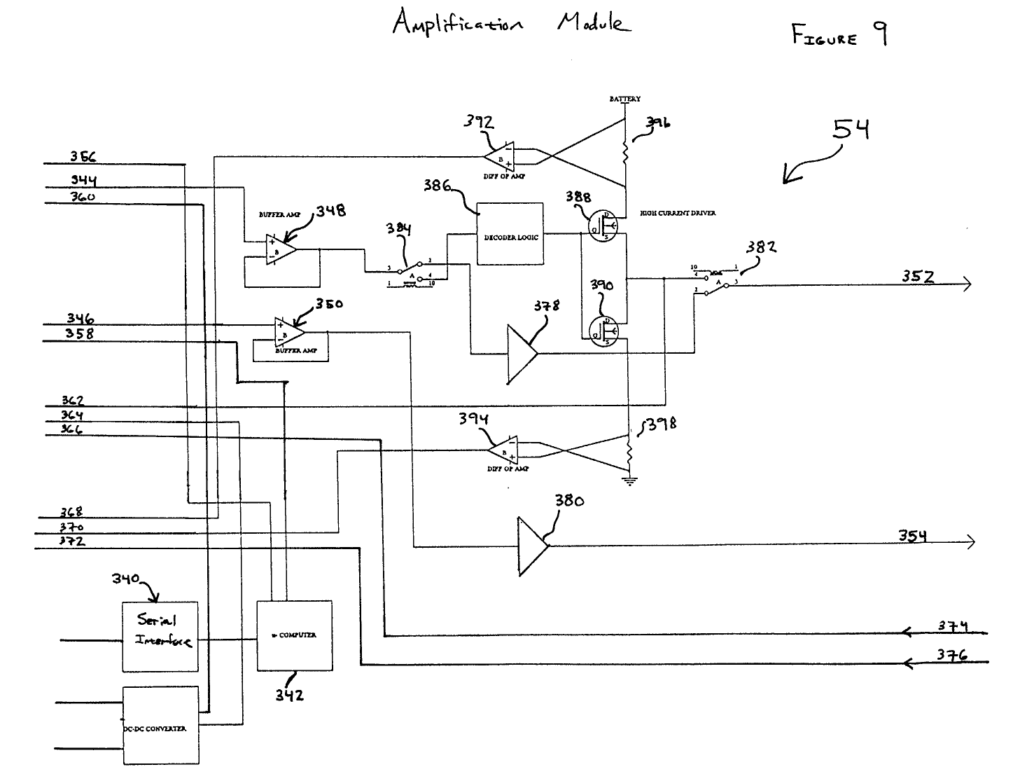

As shown in FIG. 11, multiplexer 408 includes seven cross-point switches 412 arranged in three stages. In the first stage, the input signals are provided to five 16-to-4 multiplexers. The outputs of four of the multiplexers are provided to a single 16-to-4 multiplexer in stage two. Stage 3 receives the output of stage 2 and the output of the remaining multiplexer of stage 1. Microcontroller 404 controls the operation of multiplexer 408 via control channel 414.

Microcontroller 404 may control multiplexer 408 according to a program stored in memory within microcontroller 404 or received from some other device within the vehicle diagnostic system. Microcontroller 404 may also operate according to control signals received via communication channel 416.

In the presently-preferred embodiment, user interface unit 48 issues to microcontroller 404 commands via serial interface 72. Each command is translated by microcontroller 404 into a sequence of control signals so that multiplexer 408 outputs selected vehicle computer signals to buffer circuit 410.

### Ignition System Module

In a further aspect of the invention, an ignition system signal module is provided for receiving, conditioning and processing ignition system signals. The ignition system signal module may function as a buffer between a vehicle's ignition system and the modular vehicle diagnostic system. The ignition system signal module may also adjust ignition system signal magnitudes to within ranges suitable for processing by other devices within the modular vehicle diagnostic system. The ignition system signal module may also output selected ignition signals. The ignition system signal module may perform other functions, such as comparing signal magnitudes, frequencies, or other attributes.

In the presently-preferred embodiment, an ignition signal receiver module may receive selected ignition signals from an ignition lead set 76 and provide selected, conditioned signals to diagnostic module 50, as illustrated in FIG. 2. Diagnostic module 50 processes the received signals and generates representative signals in digital format therefrom for output to user interface unit 48, as explained above.

The ignition signal receiver module of the present embodiment may receive a plurality of ignition signals from both conventional and distributorless ignition systems, including primary ignition signals, positive and/or negative secondary signals, number one cylinder signals, battery voltage and current signals, and vacuum and pressure device signals. The ignition signal receiver module processes ignition signals under the control of a microprocessor.

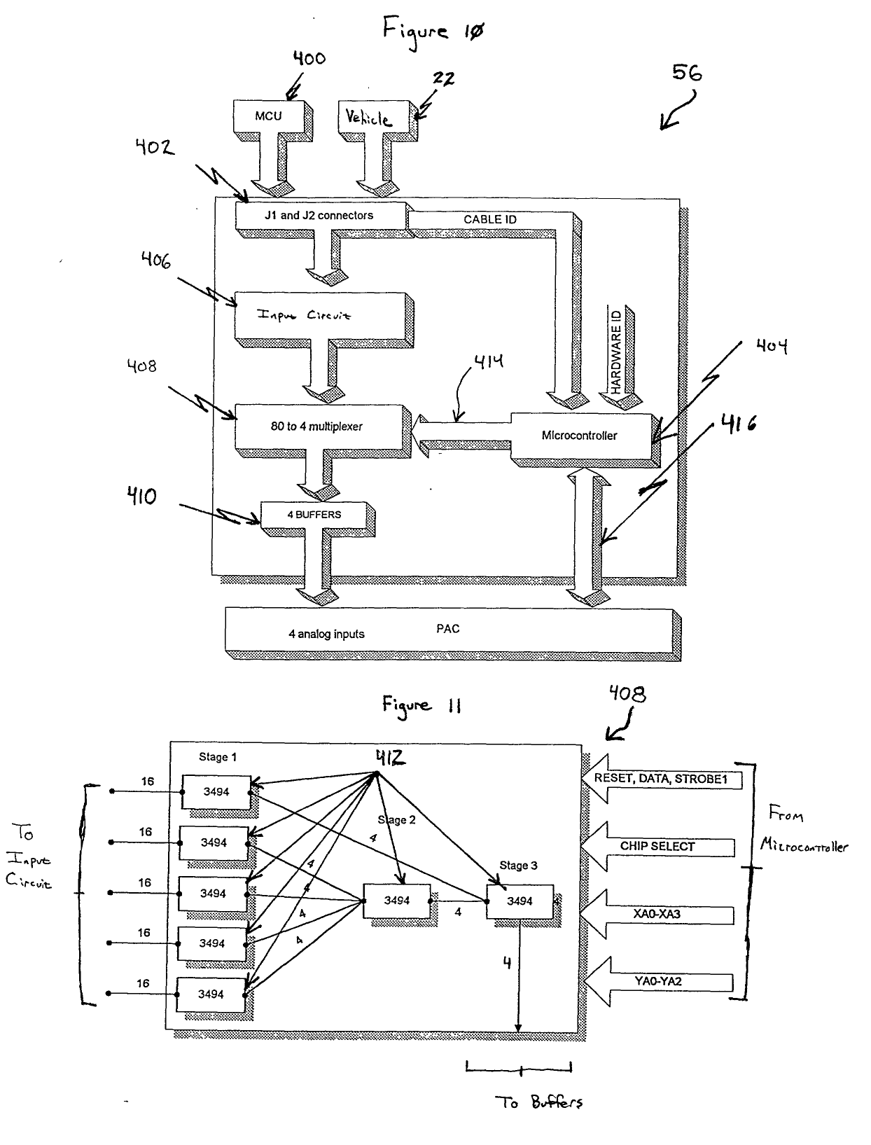

Referring to FIG. 12, ignition signal receiver module 64 may receive distributorless secondary ignition signals at terminals 420A and 422A and/or conventional secondary ignition signals at terminals 420B and 422B. Primary ignition signals may be received at terminals 424A and 424B for conventional and distributorless ignition systems, respectively. Primary and secondary ignition signals may be processed to respective signal interface networks 426-436 for conditioning. For example, in the present embodiment, the signal interface networks operate under control of a processor 440 to adjust the primary and secondary input signals to within a 0-6.5 volt range. Spark gap circuit protection components 480-490 may be provided to protect the ignition signal receiver module from excessive voltage signals from vehicle 22.

Microprocessor 440 may control the ignition signal receiver module according to a program stored in memory within microprocessor 440 or received from some other module within the vehicle diagnostic system. In the presently preferred embodiment, microprocessor 440 receives operational software from user-interface unit 48 via a serial communication channel.

Conditioned primary and secondary input signals may be buffered by buffers 442-446 and input to analog cross-point switch network 438 for selective output to signal drivers 448-454. Cross-point switch network 438, switches 442-446, and drivers 448-454 operate under control of microprocessor 440. The ignition signal receiver module outputs selected ignition signals to the modular vehicle diagnostic assembly. In the presently preferred embodiment, the ignition signal receiver module, when interconnected to a modular vehicle diagnostic assembly, outputs selected ignition signals to diagnostics module 50 input leads 178-184.

Ignition signal receiver module 64 may also include an input terminal dedicated to receiving a vehicle's number-one cylinder ignition signal. A dedicated number-one cylinder ignition terminal allows the modular vehicle diagnostic assembly to identify primary and secondary ignition signals by cylinder number.

The number-one cylinder signal may be received at input terminal 456, buffered at buffer 458, and input to analog cross-point switch circuit 438. Cross-point switch circuit 438 may output a number-one cylinder signal to a signal driver 448-454 under control of microprocessor 440.

Ignition signal receiver module 64 may also include input leads for receiving signals related to vacuum and pressure components of an ignition system. In the present embodiment, input lead 456 may receive signals from a vacuum probe and input lead 470 may receive signals from a pressure probe. Vacuum and pressure input signals processed through signal buffers, analog cross-point switch circuit, and signal divers, are output to the diagnostic module, as described above.

The ignition signal receiver module 64 may also include a current probe for monitoring battery current for testing the performance of vehicle systems such as the cranking and charging systems. In the present embodiment, a current probe detects battery current and outputs a differential voltage to differential amplifier 464. The differential voltage signal is processed to analog cross-point switch circuit 438 and to output drivers 448-454, as described above.

The ignition signal receiver module 64 may also include battery voltage circuit 474 for monitoring battery voltage and a diode ripple circuit 476 for detecting the effects of the alternator on the battery output voltage.

Battery voltage may be monitored by battery voltage circuit 474 to test the charging system and/or the output of the battery when the ignition switch is engaged.

The diode ripple circuit includes a bandpass filter for filtering out the DC and high frequency components of the battery voltage. The diode ripple circuit 476 provides the filtered battery waveform to analog cross-point switch circuit 438.

While the ignition signal receiver module of the present invention may be powered by internal or external power supplies, the present embodiment includes a DC-DC converter 478, as shown in FIG. 12, for powering ignition module components from the vehicle battery.

Auxiliary components of the present invention may include a gas analysis module, a docking station, and/or data processing and display devices.

### Gas Analysis Module

A gas analysis module may receive vehicle emission gases, measure the amount or concentration of one or several selected gases, and output a signal or signals representative thereof. Referring to FIG. 2, gas analysis module 58 receives samples of vehicle exhaust via exhaust intake hose 82. Gas analysis module 58 may analyze emission samples, generate data signals, and/or provide signals to other devices within the modular vehicle diagnostic system. The modular vehicle diagnostic system may process the signals and generate data for display or may process the data in conjunction with data received from other tests to provide vehicle performance or condition parameters. Gas analysis module 58 outputs digital data signals representative of exhaust gas concentrations to user interface unit 48 via serial communications channel 70. Gas analysis module data includes concentrations of hydrocarbons, carbon monoxide, carbon dioxide, oxygen, and oxides of nitrogen. In the present embodiment, gas analysis module 58 is manufactured by Andros (model 6600).

The gas analysis module 58 of the preferred embodiment is shown in FIG. 13. Exhaust samples received from exhaust intake hose 82 are provided to Andros gas analyzer 500. Sampled gases are discharged through outlet 508. Andros gas analyzer 500 is in serial communication with Andros board 502 via communication channel 504. Andros board 502 communicates with the modular vehicle diagnostic system via communication channel 70. In the preferred embodiment, gas analysis module 58 is in serial communication with user interface unit 48, as shown in FIG. 2. User interface unit 48 provides control signals to gas analysis module 58. Gas analysis module 58 responsively generates and outputs exhaust sample data. Exhaust data is processed by the user interface unit for display or vehicle condition or performance evaluation.

Gas analysis module 58 may also provide power to other modular vehicle diagnostic system devices. In the presently-preferred embodiment, the gas analysis module receives power from the vehicle battery. Power for the other devices is provided at power terminal 510.

### Data Processing with A Docking Station

Auxiliary components of the present invention may also include a data processing device for functioning with one or several devices within the modular vehicle diagnostic system. For example, a personal computer may communicate with selected devices for performing selected tests and for receiving and displaying diagnostic data and/or inputting control commands.

The data processing device may also perform other functions related to automotive performance evaluation but not associated with the modular vehicle diagnostic system. For example, the data processing device may also interact with other equipment in an automotive repair shop and/or function as a central hub of vehicle diagnosis, sales and inventory.

The data processing device may further perform functions not unique to automotive performance evaluation, such as work processing, accessing remote data bases, and/or driving peripheral devices, such as a printer or sound system.

In furtherance of this aspect of the present invention, a docking station 60 is provided through which a communications link between a data processing device and selected devices within the modular vehicle diagnostic system may be established. In the presently-preferred embodiment, a docking station is provided for converting data and control information between communication formats implemented by the data processing device and communication formats, discussed below, of other vehicle diagnostic system devices.

Turning once again to FIG. 2, therein is shown a docking station 60 in communication with the modular vehicle diagnostic system and data processing device 62. Data processing device 62 may include a display for displaying menu and control information and diagnostic data associated with the vehicle diagnostic system. Data processing device 62 may also include an input device, such as a keyboard or touch screen display, for inputting operator commands and other information.

Docking station 60 may include several ports for interconnection to various modular devices, including data processor 62, and may include memory and processing devices for converting between different communication formats, such as bit processing formats.

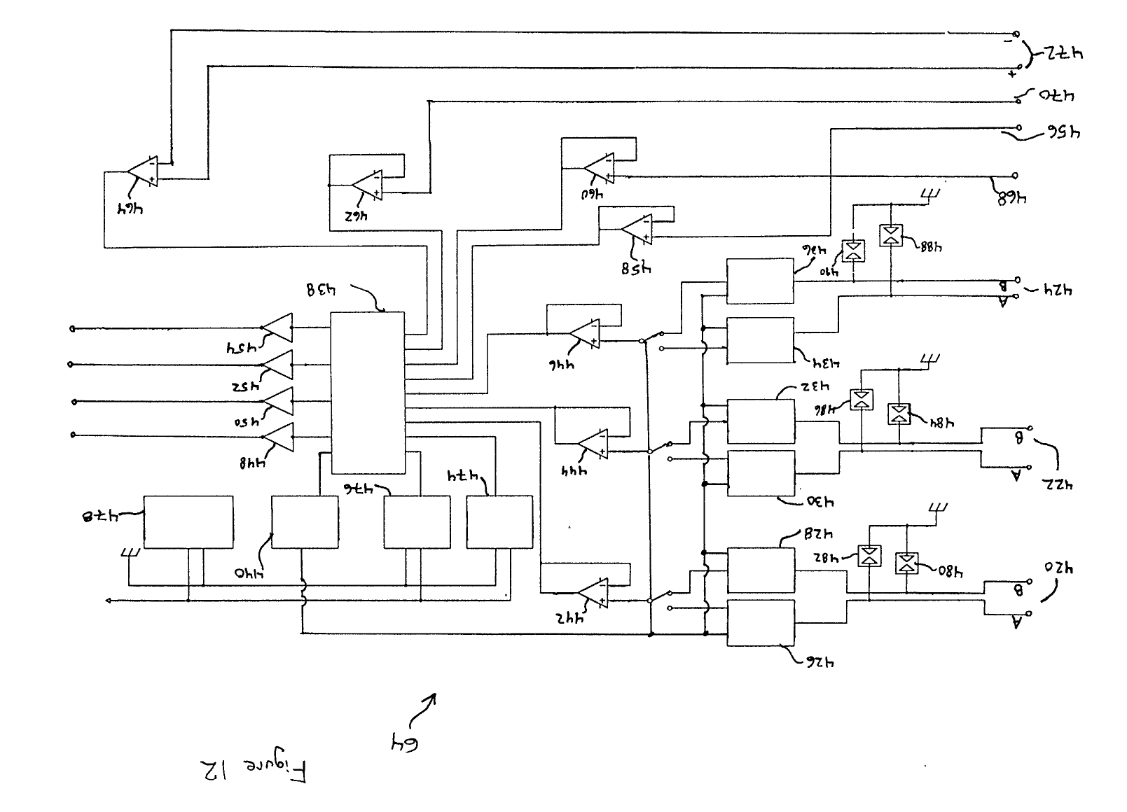

A block diagram of docking station 60 of the present embodiment is shown in FIG. 14. Docking station 60 includes several ports for interconnecting to different modular vehicle diagnostic system devices for receiving and providing signals in different formats. In the present embodiment, docking station ports have interface circuits associated therewith for adjusting output signals. For example, interface circuits 520, 522, 542, and 544 may be level shifters for providing a desired shift in voltage between input and output signals.

Docking station port 520 may receive or provide digital signals transferred serially from/to data processor 62. Docking station ports 522, 542, and 544 may receive or provide digital signals serially transferred from/to other devices within modular vehicle diagnostic system 10. In the present embodiment, docking station ports 520, 522, 542, and 544 are RS-232 serial data voltage level shifters. Devices that utilize parallel bit processing may be interconnected to docking station 60 at header 524.

The docking station 60 of the present embodiment includes a processing unit 526 for translating modular vehicle diagnostic system data between different bit processing formats. In the present embodiment, processing unit 526 translates between parallel and serial bit processing formats. Processing unit 526 is interconnected to data bus 532 and address bus 534. Data bus 532 and address bus 534 are interconnected to memory devices 528 and 530. Memory device 530 may provide memory for program storage and non-volatile data storage and memory device 530 may provide memory for use by processing unit 526 for program execution. In the presently preferred embodiment, memory device 528 is a static RAM and memory device 530 is a flash memory chip.

In the presently preferred embodiment, processing unit 526 includes a device for converting input/output signals to desired bit processing formats. In addition, dual UART (DUART) 540 may also, under the control of data processor 526, convert signals to desired bit processing formats. Both data processor 526 and DUART 540 are connected directly to data bus 532 and address bus 534, which, in turn, are connected to translator buffer 536 for processing data in parallel format to/from debug header 524 via module bus 538.

Docking station 60 further includes a logic circuit 546 and display 548 for providing an indication of the state of the device. For example, display 548 may include a series of light emitting diodes and provide a signal when the docking station is converting data.

As illustrated in FIG. 14, docking station 60 further includes a power supply circuit 550 for providing docking station 60 with power. In the presently preferred embodiment, power supply circuit 550 is interconnected to a 12 volt DC external power source at input 554 and provides 5 volt and +/−12 volt voltages to docking station components.

Docking station 60 may further include a reset circuit 552 for providing a reset signal to data processor 526.

In the preferred embodiment, data processor 526 is an AM186ES microcontroller.

A data processing device may also be interconnected to other devices within the modular vehicle diagnostic system 10. For example, a desktop PC may be serially linked to one of the modules, such as the user interface unit 48, for receiving diagnostic data. The diagnostic data may be transmitted to the desktop PC as it is acquired or may be transmitted from memory. The data processing device may utilize, store, process, or further transfer the information.

In the preferred embodiment of the present invention, a data processor 62 may be serially linked directly to the user interface unit 48 via a serial data cable 74. The serial link allows the transfer of selected diagnostic data, stored as files within the user interface unit 48, from the user interface unit to the data processor. In the present embodiment, data is transferred in accordance with the modular vehicle diagnostic system serial communications protocol, discussed below. It is preferred that the data processor 62 support the diagnostic functions provided by the other modules, so that diagnostic data may be similarly presented on the user interface unit and the data processor 62 displays.

### Communication Channels

As described above, the modular vehicle diagnostic system of the present embodiment includes a plurality of devices that may be selectively interconnected. An interconnection, for purposes of the present invention, includes establishing at least one communication channel between a selected device and at least one other device within the modular vehicle diagnostic system. A communication channel may require a solid medium, such as a conductive metal. Data may also be communicated between devices by other modes such as through radio waves or electromagnetic radiation.

As described above, several pairs of devices, if interconnected, communicate serially. Because different devices may be connected to a serial port and selected serial communications may be bi-directional, it is preferred that one serial communications protocol be implemented for all devices that input/output data serially.

In the present embodiment, communications between user interface unit 48 and programmable break-out-box 56, amplification unit 54, gas analysis module 58, and data processor 62 occur via serial communication channels. In keeping with the invention, a universal serial communications protocol for all serial communications is defined, thus simplifying the communications code and providing the user interface unit 48 with a consistent mechanism through which to identify devices.

For purposes of the present discussion, user interface unit 48 is the host when communicating with programmable break-out-box 56, gas analysis module 58, or amplification unit 54. Data processor 62 is the host when communicating serially with any device.

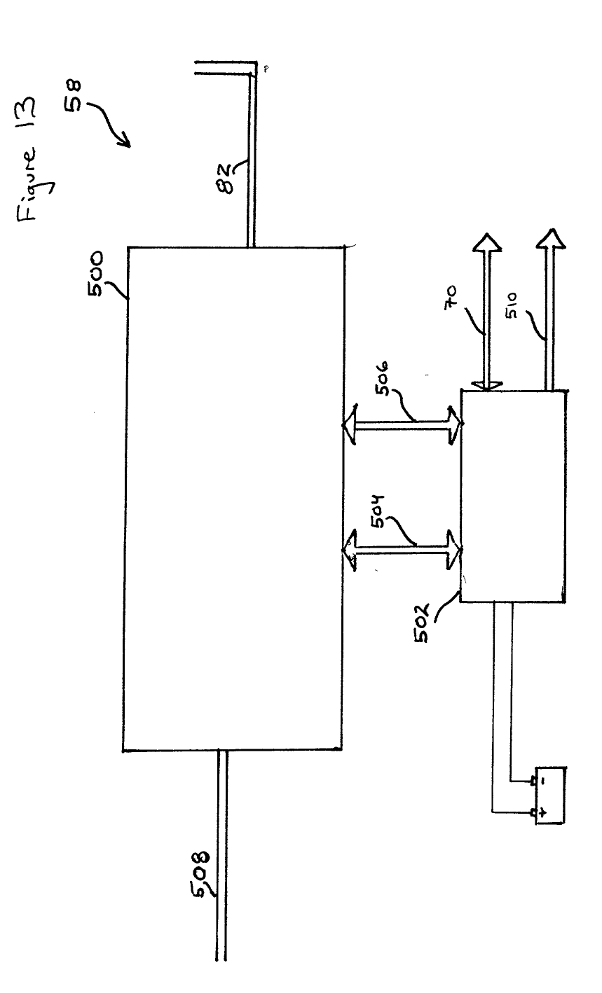

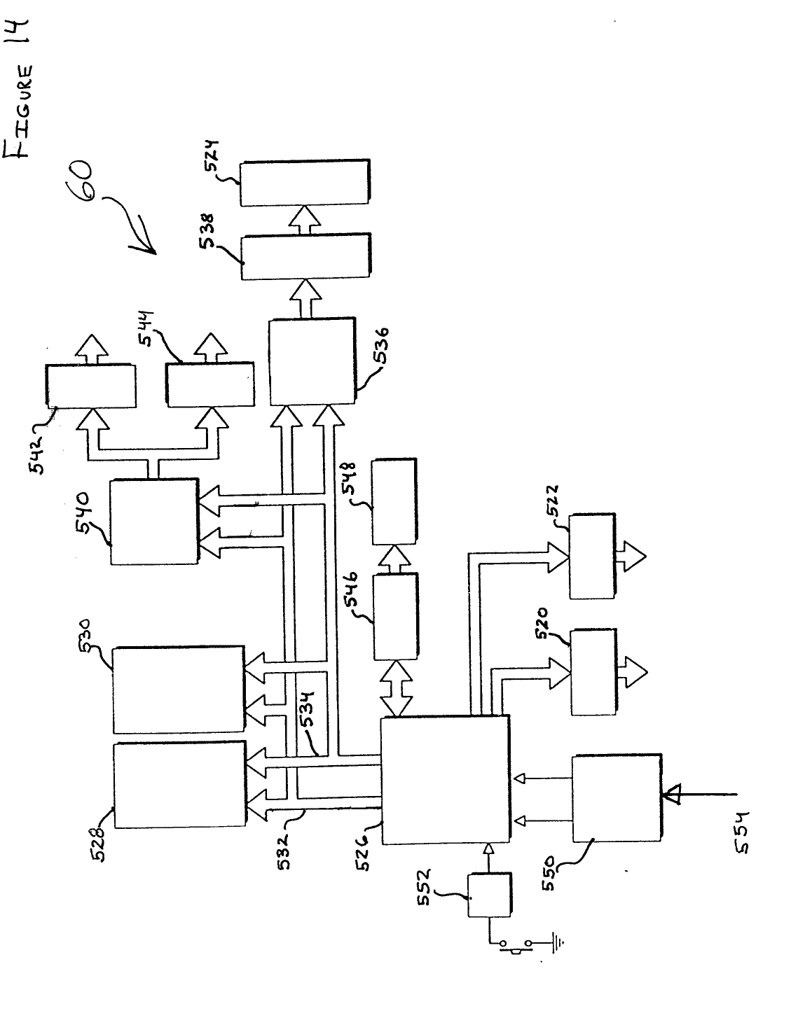

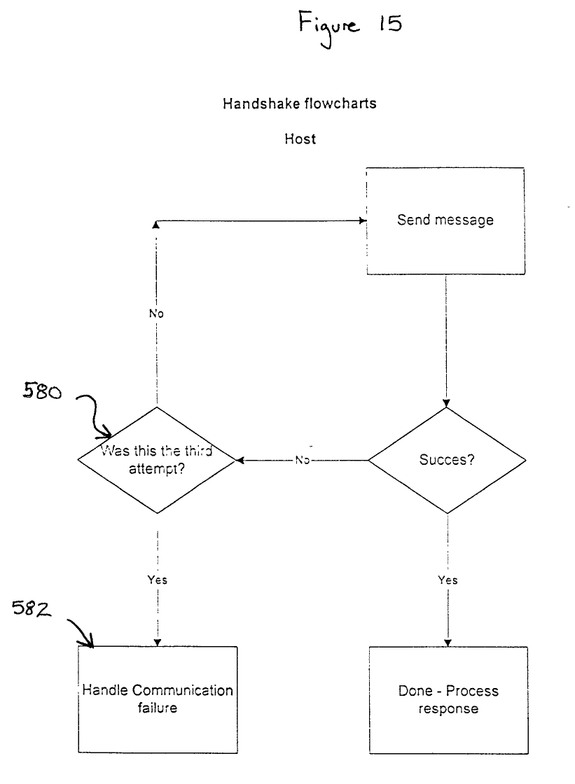

In the preferred serial communications protocol, the host always initiates communications. A flowchart of the handshake protocol for the host is shown in FIGS. 15 and 16. As shown in FIG. 15, if the transmission of a message is not successful, the host will resend the message up to two more times. If three successive attempts are not successful, the host records a communication failure.

As shown in FIG. 16, the host requires an acknowledge message from a target device after transmitting a message. If the acknowledge message is negative, the host will retransmit the message. If the acknowledge is positive, the host waits for a response. If a response is received within a predetermined period of time, the host determines if the checksum byte is valid. If the checksum byte is valid, the message was successfully sent. If the message was not successfully sent, the host may resend the message or record a communication failure, as discussed above.

A flowchart for the handshake protocol for a target is shown in FIG. 17. As shown therein, upon receipt of a message, the target determines if the checksum byte is valid. If checksum is valid, the target transmits a positive acknowledge (ACK) signal, processes the message, and sends a response. Upon receipt of a response message, the host does not send an acknowledgment. However, if checksum is not valid, the target transmits a negative acknowledge (NAK). As discussed above, if the transfer of a message is not successful, the host will resend the message up to two more times. If the target receives a defective message, it waits until the host stops transmitting before sending NAK.

The host and response message structures for the preferred embodiment are as follows:

Host message structure

| | |
|---|---|
| Header: | message size - 2 bytes |
| | target id - 1 byte |
| | opcode - 1 byte |
| | checksum - 1 byte |
| Message: | Length is opcode specific |

Response message structure

| | |
|---|---|
| Header: | message size - 2 bytes |
| | target id - 1 byte |
| | status - 1 byte |
| | checksum - 1 byte |
| Message: | Optional |

The target identification bytes for the preferred embodiment are defined as follows (“$” denotes hexadecimal):

Target id byte

| | |
|---|---|
| $00 | Any - all targets respond |
| $01 | programmable break-out-box |
| $02 | amplification unit |
| $03 | computer |
| $04 | slave PAC |

The status byte in the preferred embodiment is defined as follows:

Status Byte

| | |
|---|---|
| $00-$0F | Reserved for universal codes |
| $00 | OK |
| $01 | Wrong target id |
| $02 | Invalid opcode |
| $03 | Target has been reset |
| $04 | Invalid parameter |
| $10-$2F | programmable break-out-box error |
| | codes |
| $30-$4F | amplification unit error codes |
| $50-$6F | computer error codes |
| $70-$8F | slave error codes |

The serial communications protocol of the preferred embodiment thus allows bi-directional communication between two selected devices and includes a mechanism that verifies the identification of the device and message. The preferred protocol further allows for an expansion of the modular vehicle diagnostic system to include additional modules.

### Modularity

As discussed above, the devices of the modular vehicle diagnostic system may be selectively conjoined. One or more mechanisms may be used to conjoin the selected devices. A conjoining mechanism may provide or facilitate a desired feature of the modular vehicle diagnostic system. For example, a mechanism may facilitate the establishment of a hardware communication channel and/or maintain a structural concept. For example, it is desirable that the vehicle diagnostic assemblies of the preferred embodiment be portable and readily operable by a single operator, i.e., handheld.

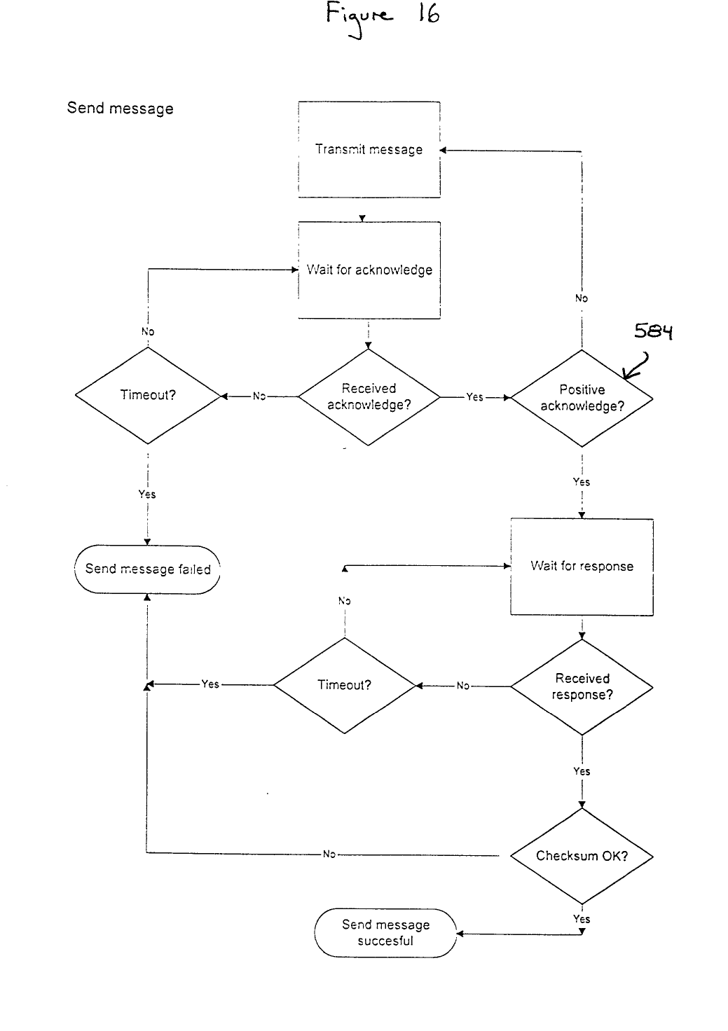

The several devices of the preferred embodiment are housed separately. User interface unit housing 600 is shown in FIGS. 18 and 19. Housing assembly 600 is of a generally rectangular shape that includes side surface 602 opposite user interface surface 616. User interface surface 616 includes display and touch screen interface 618.

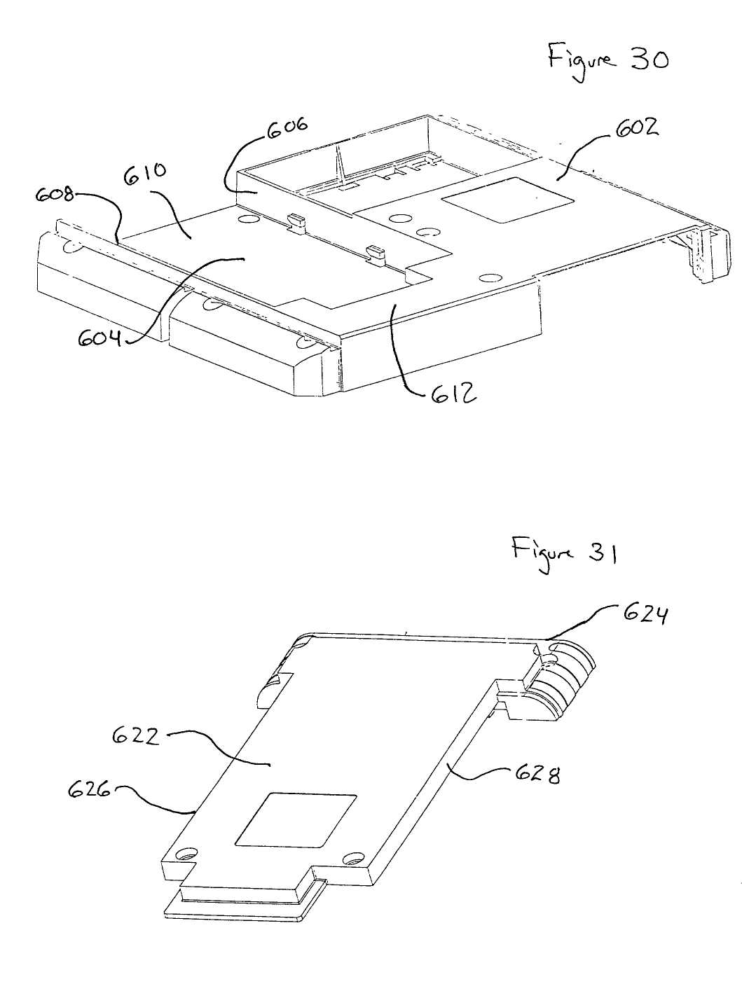

Side surface 602, further illustrated in FIG. 30, has a slot or aperture 604 formed therein. In the present embodiment, aperture 604 includes a left side 606 and a right side 608 and terminates at an open end 610 and closed end 612. Closed end 612 includes a male electric connector 614, discussed below, that provides a hardware interface for interconnection to other devices of the modular vehicle diagnostic assembly. Aperture 604 is formed to provide an opening that corresponds to the shape of one or several other modular vehicle diagnostic system devices. For example, in the present embodiment, aperture 604 corresponds to the shape of the housings of diagnostic module 50 and scan tool module 52.

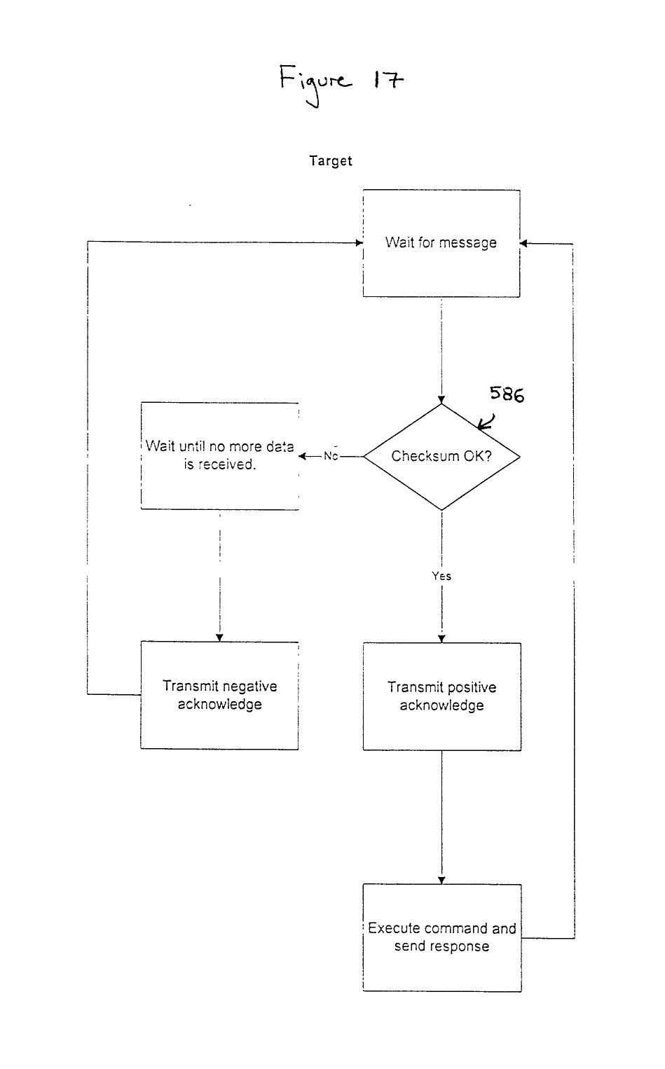

Turning to FIGS. 20 and 21, therein is shown the shape of the housing 620 for both diagnostic module 50 and scan tool module 52. Housing assembly 620, is analogous to a key that includes two portions, as further illustrated in FIG. 31. The first portion may be referred to as mating segment 622 and the second portion may be referred to as the access segment 624. Mating segment 622 is of a shape complimentary to aperture 604, discussed above. In the present embodiment, mating segment 622 includes a left side and a right side, 626 and 628, respectively, having apertures formed therein to complement the ridges formed in sides 606 and 608 of aperture 604. The width of mating segment 622 is equal to the depth of aperture 604. The horizontal and vertical lengths of mating segment 622 correspond to the horizontal and vertical lengths of aperture 604. Mating segment 622 further includes female electronic connector 630, shaped complementary to male electronic connector 614, discussed above.

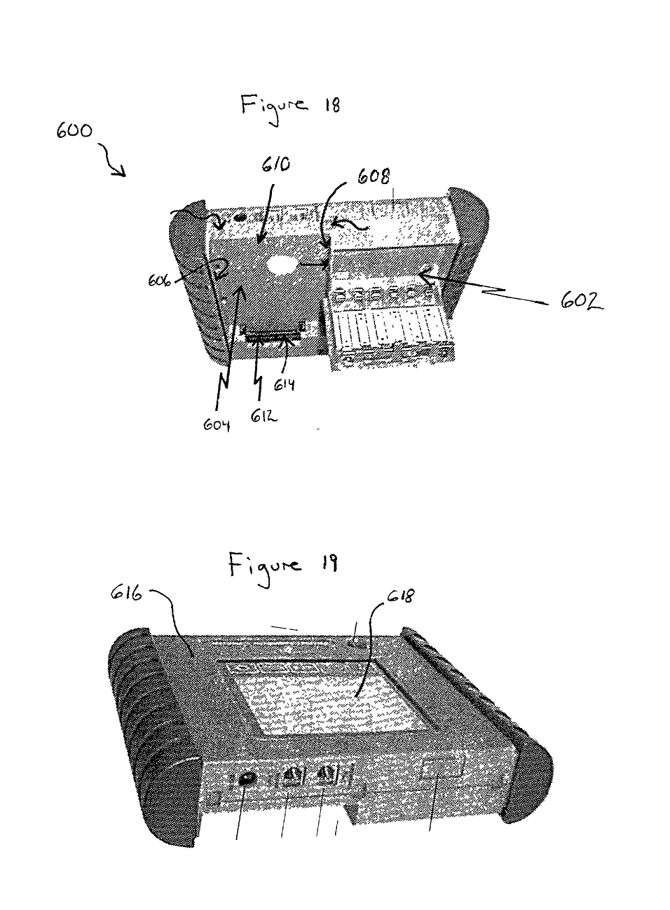

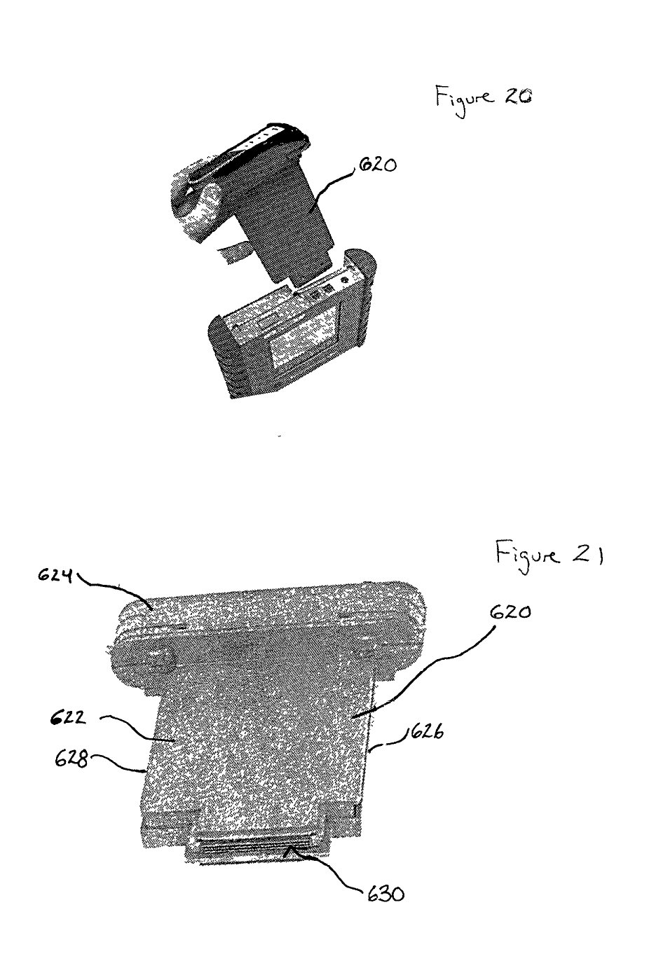

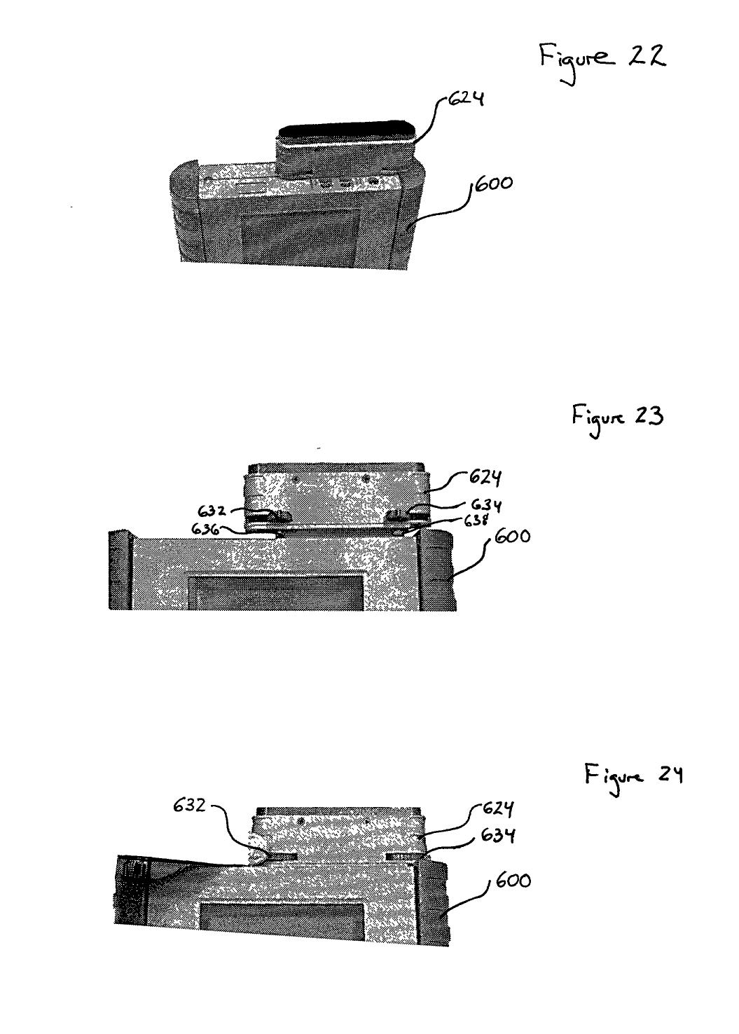

Housing 620 may be conjoined to user interface unit housing 600 by sliding mating segment 622 adjacent to and along the length of aperture 604. When housing 620 is fully inserted in aperture 604, female electric connector 630 is in contact with male electric connector 614, mating segment 622 and side surface 602 form a substantially flat surface, and access segment 624 is accessible atop user interface unit housing 600, as shown in FIG. 22.

The present embodiment of user interface unit housing 600 includes a pair of rectangular apertures for receipt of a pair of rotating tabs 636 and 638 associated with locking latches 632 and 634 integrated with access segment 624. When housing 620 is fully inserted into user interface unit housing 600, manual rotation of tabs 632 and 634 locks housing 620 in the fully inserted position, as shown in FIGS. 22 and 24. In the presently preferred embodiment, locking the latches allows an operator to handle user interface unit 48 and diagnostic module 50 or scan tool module 52 as a single device. Of course, other modular vehicle diagnostic system devices may be conjoined and interconnected as described. Diagnostic module 50 and/or scan tool module 52 may be conjoined and/or interconnected through other mechanisms known in the art.

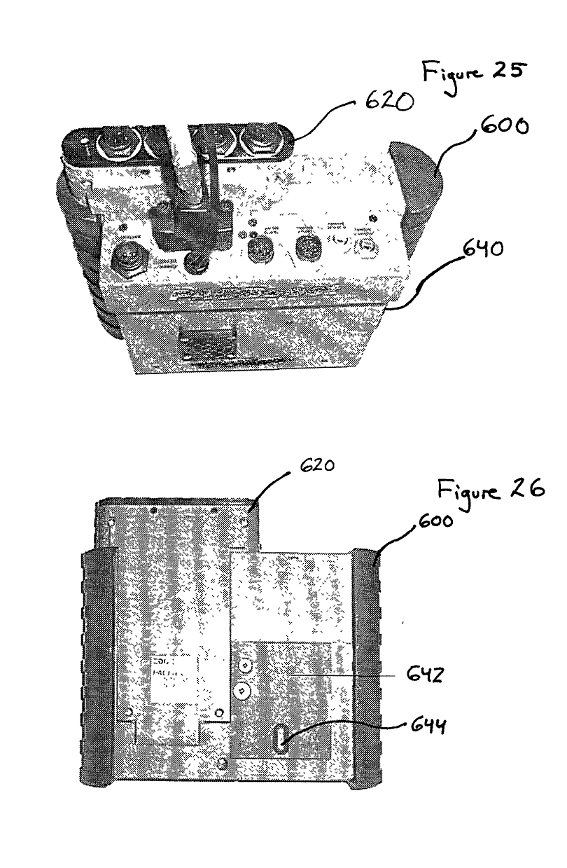

The devices of the modular vehicle diagnostic system may be conjoined by other mechanisms. Referring to FIG. 25, the amplification housing 640 for the amplification unit 54 is shown in its preferred position as conjoined to user interface unit housing 600. Housing 620 is also shown conjoined to user interface unit housing 600, to illustrate the preferred relation of amplification unit 54 to diagnostic module 50 and user interface unit 48, discussed above.

Amplification housing 640 may be conjoined to other devices within the modular vehicle diagnostic assembly through a number of different mechanisms. As shown in FIG. 26, the preferred mechanism includes a bracket 642 secured to the back of the user interface unit housing 600 securing amplification housing 640 to user interface unit 48. Bracket 642 includes a slot 644 for receipt of key tabs affixed to the back of amplification housing 640. The key tabs may be slid into slot 644. Amplification housing 640 may also include spring loaded nylon balls for exerting a constant force between amplification housing 640 and user interface unit housing 600 when the key tabs are inserted into slot 644. The force exerted by the spring holds amplification housing 640 in a fixed position relative user interface unit housing 600.

In the present embodiment, gas analysis module 58 also has a housing with key tabs for insertion in slot 644, as described above.

As discussed earlier, modular vehicle diagnostic system devices may conjoin through other mechanisms. For example, devices may be conjoined by a threaded stud and nut assembly. One or several threaded studs may be affixed to one or several devices. Corresponding apertures may be associated with other devices. Two or several devices may be conjoined by inserting a stud through an aperture. The devices may be secured together by tightening a nut on the stud.

As illustrated in FIG. 2 and explained in detail above, it may be necessary to establish communication channels between selected devices. The communication channels may, in certain applications, be associated with the conjoining mechanism. For example, as shown above, a parallel communication channel between user interface unit 48 and diagnostic module 50 or scan tool module 52 is established when housing 620 is fully inserted in aperture 604 and female electronic connector 630 contacts male electric connector 614. Other types of communication channels may be established between devices. For example, a serial communication channel may be established between devices when a housing is inserted into an aperture.

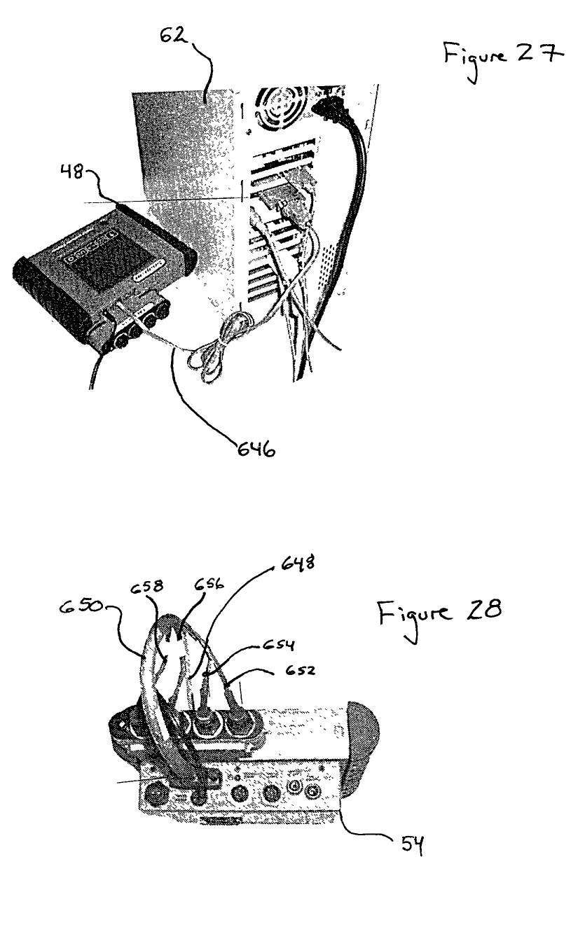

Communication channels may be established through mechanisms not associated with the device housings. As shown in FIG. 2, user interface unit 48 may communicate with data processor 62 via serial communication channel 74. Data processor 62 may or may not conjoin user interface unit 48. For example, as shown in FIG. 27, serial data cable 646 may provide the only physical link between data processor 62 and user interface unit 48. Alternatively, separate communication links may be established between devices that are conjoined. As shown in FIG. 2, user interface unit 48 may communicate with amplification unit 54 via serial communication channel 72 and diagnostic module 50 may communicate with amplification unit 54 via analog channels 88. Amplification unit 54 may also conjoin user interface unit 48, as shown in FIG. 25. Turning to FIG. 28, therein is shown interface cable 650 interconnected to amplification unit 54. Interface cable 650 also includes serial data cable 648 for establishing serial communication channel 72 between user interface unit 48 and amplification unit 54. Analog channels 88 may be established between diagnostic module 50 and amplification unit 54 via analog cables 652-658.

### Conclusion

The modular system described herein permits a user to select which modules or devices to conjoin in a plug-in system. The system provides an automotive service professional with all the tools necessary to perform precision fault analysis of sophisticated vehicle components.

As discussed above, the modular vehicle diagnostic system is preferably handheld. A handheld system accords an operator of the device the mobility to easily access different vehicle components while maintaining immediate control of the system. As test results are reviewed, new connections to the vehicle under test may be made. An operator may thereby perform vehicle tests without having to walk away from the vehicle.

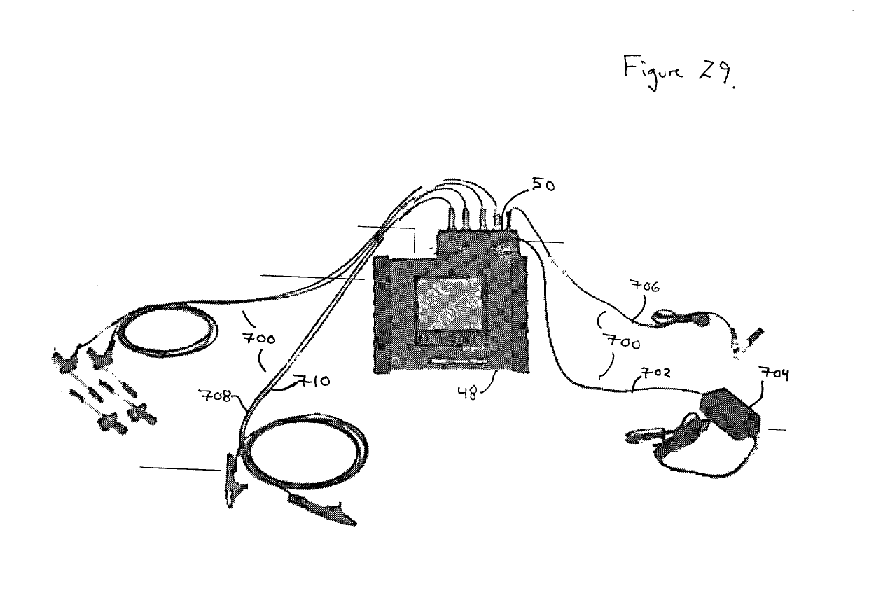

To diagnose a vehicle, a mechanic chooses the component or system to be tested and interconnects the modules or devices for performing the desired test. For example, a mechanic that would like a display of the secondary ignition signals of a distributorless ignition system would first conjoin the diagnostics module to the user interface unit. The mechanic would also plug the diagnostic module lead set into the diagnostic module and provide a connection from a power source to the user interface unit. FIG. 29 shows the user interface unit 48 conjoined with the diagnostics module 50 and the lead set 700. The lead set includes power lead 702 connecting AC power supply adapter 704 to the user interface unit 48. The AC power supply adapter includes a plug for connection to an AC power supply.

The lead set further includes a ground lead 706 for connection to vehicle ground. Secondary leads 708 and 710 are connected to the diagnostic module 50 channels as shown. After selecting the DIS ignition system display from the touch screen of user interface 48, the mechanic follows the instructions provided on the display for configuring the diagnostic module 50 and connecting the leads to the vehicle. After the user interface unit is properly configured and the test leads are properly connected, the mechanic is prompted to start the test.

Upon starting the test, the user interface provides a display of DIS signals to the mechanic. The mechanic may select a graphical or digital display of data.

A user interface unit serves as a base unit for various assemblies. Additional modules or devices may be obtained at the discretion of a mechanic. For example, a mechanic dedicated to ignition system repair may obtain or purchase only an ignition signal receiver and a diagnostics module. Additional modules, such as a gas analysis module or a scan tool module, may be obtained if the need or desire to expand the capacity of the diagnostic system arises. Further, if advances in automotive or diagnostic technology render a particular module or device out-of-date, that module or device may be replaced without having to replace other devices or modules, such as the user interface unit.

While the invention has been particularly shown and described with reference to certain preferred embodiments, it will be understood by those skilled in the art that various alterations and modifications in form and in detail may be made therein without departing from the spirit and scope of the invention.

I claim:

1. A modular automotive diagnostic system comprising:
a plurality of devices for selective interconnection to compose a diagnostic assembly unit;
a first one of said devices substantially enclosed by a first housing and having a first conjoining mechanism associated therewith;
a second one of said devices substantially enclosed by a second housing and having a second conjoining mechanism associated therewith; and
wherein said first conjoining mechanism is configured to mate with said second conjoining mechanism so that said first and said second devices can be selectively conjoined.

2. The modular automotive diagnostic system of claim 1 further comprising:
a first communication channel selectively established between selected ones of said plurality of devices.

3. The modular automotive diagnostic system of claim 2 wherein said first one of said devices includes a user interface having a display and an input device and said second one of said devices senses signals from a vehicle engine and provides digital representations thereof to said first one of said devices.

4. The modular automotive diagnostic system of claim 2 wherein said first communication channel is established when said first housing is conjoined to said second housing.

5. The modular automotive diagnostic system of claim 2 wherein said first communication channel comprises a serial data cable having a first end for connection to said first one of said devices and having a second end for connection to said second one of said devices.

6. The modular automotive diagnostic system of claim 1 wherein said plurality of devices includes at least one signal processing device selected from the group comprising:
(a) a user interface unit;
(b) a diagnostic module;
(c) a scan tool module;
(d) a gas analysis module;
(e) an ignition signal receiver;
(f) an amplification unit;
(g) a programmable break-out box;
(h) a docking station; and
(i) a data processor.

7. The modular automotive diagnostic system of claim 2 further comprising at least one serial communication channel selectively established between a first selected pair of said plurality of devices and at least one parallel communication channel selectively established between a second selected pair of said plurality of devices.

8. The modular automotive diagnostic assembly of claim 1 wherein said diagnostic assembly unit is a handheld device.

9. In a modular automotive diagnostic system, a processing device for conjoining to a user interface unit substantially enclosed by a user interface housing having a receiving aperture formed therein, said processing device comprising:
a device housing shaped complementary to said receiving aperture; and
a modular interface for establishing a communication link between said user interface unit and said processing device when said processing device housing is conjoined to said user interface housing.

10. The modular automotive diagnostic system of claim 9 wherein said user interface housing has a rectangular aperture formed therein and said processing device housing further comprises:
a mating segment having sides having apertures formed therein for engagement to said user interface housing; and
an access segment abutting said mating segment and having at least one rotating tab having at least a first position for insertion into said rectangular aperture and a second position for locking said device housing in conjoinment with said user interface housing.

11. The automotive diagnostic system of claim 9 wherein conjoining said processing device housing to said user interface housing comprises a handheld diagnostic assembly unit.

12. A first processing device suitable for selective interconnection to a second processing device in a modular automotive diagnostic system for composing handheld diagnostic assembly units, said first processing device comprising:
a housing substantially defining a first processing device periphery and having a portion suitable for abutting said second processing device in a first relative position to said second processing device; and
a conjoining mechanism for securing said housing to said second processing device in said first relative position.

13. The first processing device of claim 12 wherein said conjoining mechanism secures said housing to a second processing device selected from the group comprising:
(a) a user interface unit;
(b) a diagnostic module;
(c) a scan tool module;
(d) a gas analysis module;
(e) an ignition signal receiver;
(f) an amplification unit;
(g) a programmable break-out box;
(h) a docking station; and
(i) a data processor.

14. A handheld modular automotive diagnostic tool comprising:
a user interface unit having a user interface housing that substantially encompasses a processor, an operating system, and a display;
a vehicle signal and data interfacing module for performing selected automotive diagnostic functions and for providing diagnostic data;
a first interconnecting mechanism conjoining said vehicle signal and data interfacing module to said user interface module for composing a vehicle diagnostic assembly; and
wherein said vehicle signal and data interfacing module is outside said user interface housing.

15. The handheld modular automotive diagnostic tool of claim 14 further comprising:
a vehicle signal and data preconditioning module for performing selected automotive diagnostic signal processing functions; and
a second interconnecting mechanism conjoining said vehicle signal and data preconditioning module to said vehicle diagnostic assembly.

16. The handheld modular automotive diagnostic tool of claim 14 further comprising:
an auxiliary component; and
a third interconnecting mechanism conjoining said auxiliary component to said vehicle diagnostic assembly.

17. A method for measuring the conductivity of a circuit from a selected point in the electrical system of a vehicle to the negative terminal of a vehicle battery, comprising the steps of:
connecting the positive terminal of a vehicle battery to a known resistance connected in series to the selected point in the electrical system;
measuring the resultant drop in voltage across said known resistance; and
calculating the resistance from the selected point to the negative terminal of the vehicle battery based upon said resultant voltage drop, the voltage at the selected point, and said known resistance.

18. An apparatus for measuring the conductivity of a circuit defined by a path from a selected point in the electrical system of a vehicle to the negative terminal of a vehicle battery, comprising:
a vehicle battery having a positive terminal and a negative terminal;
a known resistance having a first terminal interconnected to the positive terminal of said battery and having a second terminal interconnected to said selected point;
a differential amplifier for providing a voltage magnitude defined by a drop in voltage across said known resistance; and
a processor for calculating said conductivity of said circuit based upon the voltage at said second terminal of said known resistance, said voltage magnitude, and said known resistance.

19. An apparatus for providing a simulated signal for testing automobile components, comprising:
digital data representative of the time varying magnitude of said signal;
a converter for converting said digital data to an analog waveform;
an amplification circuit for amplifying said analog waveform to within a first predetermined voltage range;
a voltage shift circuit for shifting said analog waveform a predetermined voltage; and
a voltage gain circuit for amplifying said analog waveform to within a second predetermined voltage range.

20. The apparatus of claim 19 wherein said digital data is provided by a digital data recording device selected from the group consisting of:
(a) random access memory;
(b) read only memory;
(c) flash card memory; and
(d) digital signal processor.

21. The apparatus of claim 19 wherein said second predetermined voltage range is from negative sixteen volts to positive sixteen volts.

22. An apparatus for providing selectable driving signals for input to an automobile component for controlling the operation of the automobile component, said apparatus comprising:
a processor for receiving a voltage signal representative of said driving signal and for providing control signals;
a first high current driver interconnected to a high current source and responsive to said control signals for outputting first driving signals;
a second high current driver interconnected to a high current sink and responsive to said control signals for outputting second driving signals; and
wherein said first driving signals and said second driving signals comprise said selectable driving signals.

23. The apparatus of claim 22 further comprising:
a first resistor interconnected between said high current source and said first high current driver;
a first differential amplifier for providing a first voltage drop magnitude across said first resistor; and
a processing device for receiving said first voltage drop magnitude and for determining the magnitude of said first driving signal therefrom.

24. The apparatus of claim 23 further comprising:
a second resistor interconnected between said high current sink and said second high current driver;
a second differential amplifier for providing a second voltage drop magnitude across said second resistor; and
a processing device for receiving said second voltage drop magnitude and determining the magnitude of said second driving signal therefrom.

25. The apparatus of claim 22 wherein said apparatus is comprised within a diagnostic assembly unit of a modular automotive diagnostic system.

26. A modular automotive diagnostic system comprising:
first and second modular diagnostic devices substantially contained in first and second housings, respectively,
said first and second housings being selectively engagable by conjoining respective housings or portions thereof.

27. A handheld modular automotive diagnostic system comprising:
a plurality of devices for selective interconnection for processing automotive diagnostic information;
a communication channel selectively established between a first one of said devices and a second one of said devices.

28. The handheld modular automotive diagnostic system of claim 27 wherein said first one of said devices is suitable for handheld operation and includes a user interface as an integral part thereof for receiving operator input and for providing a display.

29. The handheld modular automotive diagnostic system of claim 27 wherein said communication channel is a digital communication channel.

30. The handheld modular automotive diagnostic system of claim 27 wherein said communication channel is an analog communication channel.

31. The handheld modular automotive diagnostic system of claim 29 wherein said digital communication channel transmits serial data signals.

32. The handheld modular automotive diagnostic system of claim 27 wherein said communication channel transmits electromagnetic radiation signals.
